(19) United States
(12) Patent Application Publication
(10) Pub. No.: US 2002/0184381 A1
(43) Pub. Date: Dec. 5, 2002

(54) Method and apparatus for dynamically controlling data flow on a bi-directional data bus

(75) Inventors: Andrew C. Ryan, St. Louis, MO (US); Otto A. Schmid, St. Louis, MO (US); Matthew D. Rossmiller, St. Louis, MO (US)

Correspondence Address: THOMPSON COBURN, LLP, ONE FIRSTAR PLAZA, SUITE 3500, ST LOUIS, MO, 63101, US

(73) Assignee: Celox Networks, Inc.

(21) Appl. No.: 09/870,400

(22) Filed: May 30, 2001

(51) Int. Cl. G06F 15/16

(52) U.S. Cl. 709/234

(57) ABSTRACT

Disclosed herein is a method and apparatus for dynamically controlling data flow on a bi-directional data bus. Windows of time on the bus are divided between input, output, and pointer transactions. The number of input transactions relative to the number of output transactions is dynamically determined as a function of an input/output bias factor. Input transactions are written to a plurality of input queues (IQs) over the bus, and output transactions are read from a plurality of output queues (OQs) over the bus. The IQ receiving an input transaction is selected at least in part according to the occupancies of the IQs relative to a threshold occupancy. The number of output transactions allocated to an OQ during a window is determined as a function of that OQ's occupancy. Pointer transactions comprise reading or writing two copies of the pertinent pointers to prevent pointer corruption resulting from simultaneous pointer read/write accesses.

### TECHNICAL FIELD

The present invention relates to scheduling input data streams and output data streams that travel over a bi-directional data bus.

### BACKGROUND OF THE INVENTION

FIG. 1 depicts a block diagram of the logical data flow topology in which the present invention can be used. A high speed aggregate input data stream 100 is split into a plurality of lower speed input data streams 104 (input direction traffic) to be processed in parallel by a plurality of processing elements 108. This topology is useful when a high speed data stream needs to be processed by processing elements that cannot handle the high speed data flow. By separating the high speed aggregate input data stream into a plurality of parallel lower speed input data streams, the parallel processing elements will have more time to process data. The processing elements can be any type of device that processes data, including but not limited to devices that perform packet inspection, packet classification, packet switching, packet routing, traffic shaping, traffic policing, traffic prioritization, etc.

The processed data streams 112 (output direction traffic) are then multiplexed into a high speed aggregate output data stream 116. The data streams are comprised of a plurality of words. Each word is preferably comprised of 64 bits of data and 8 bits of parity (72 bits total). Those of ordinary skill in the art would recognize that a word can be any plurality of bits transferred in a cycle. The plurality of words may together comprise a plurality of data segments, each data segment comprising at least one word. For example, in networking applications, the data segments can be packets comprising a variable number of words or cells comprising a fixed number of words.

An aggregate ingress queue (AIQ) 102 is used to store the words comprising the high speed aggregate input data stream. Words are stored in the AIQ while they await distribution into one of the lower speed data streams 104. A plurality of input queues (IQs) 106 are used to store words in each of the lower speed input data streams. Each input data stream 104 should feed words into at least one IQ 106. Words are stored in IQs while they await transmission to one of the processing elements 108.

After words are processed by the processing elements 108, they are next sent to an output queue (OQ) 110 while they await being multiplexed back to a high speed flow. Each processing element 108 will supply words to at least one OQ 110. An aggregate egress queue (AEQ) 114 is used to store words that are multiplexed from a plurality of lower-speed output data streams 112 to a high speed aggregate output data stream 116. A single bi-directional data bus is used to transfer both the input streams of data 104 going from the AIQ 102 to the IQs 106, and the output streams of data 112 going from the OQs 110 to the AEQ 114.

When a single bi-directional data bus is used to move input direction traffic and output direction traffic, access to the bus will need to be arbitrated between the input direction traffic going from the AIQ 102 to the IQs 106 and an output direction traffic going from the plurality of OQs 110 to the AEQ 114.

Prior art methods for managing bi-directional data flow fail to address how to efficiently arbitrate between input direction and output direction traffic. For example, U.S. Pat. No. 5,519,701 issued to Colmant et al. discloses a queue manager that manages traffic for a plurality of interfaces. In managing the data flow, the queue manager serves traffic on an interface basis without regard to whether the traffic is input direction or output direction traffic, which may lead to an unbalanced situation where a given traffic direction having a high volume is underserved in relation to a traffic direction having a low volume.

Moreover, conventional methods of traffic management have failed to address how IQs and OQs can be satisfactorily implemented in DPRAMs, and have failed to address how memory-based pointers may be transferred across mutually asynchronous clock domains.

### SUMMERY OF THE INVENTION

The present invention addresses how data flow on a bi-directional data bus can be dynamically controlled to efficiently arbitrate between input direction traffic (data going over the data bus toward a processor, referred to herein as input transactions) and output direction traffic (data going over the data bus away from the processor, referred to herein as output transactions).

FIG. 2 shows a realized topology for the data flow shown logically in FIG. 1. An aggregate input data stream 100 is stored in the AIQ 102. The AIQ 102 has a plurality of addresses therein for storing the words of the aggregate input data stream. A queue manager 118 links the AIQ 102 with a plurality of IQs 106 via the bi-directional data bus 120. Words are stored in addresses in the IQs 106 and are then processed by the processing elements 108. The processing elements 108 then send processed words to addresses in the OQs 110, where they await transmission to the AEQ 114. The queue manager 118 links the plurality of OQs 110 with the AEQ 114 via the bi-directional data bus 120, and controls when the input direction traffic and the output direction traffic have access to the bus.

In the present invention, access to the bi-directional data bus is broken up into windows of time. These windows are then divided into frames: an input scheduling frame, an output scheduling frame, and a pointer scheduling frame. However, it must be noted that a pointer scheduling frame is not necessary if the IQs and OQs are not implemented in DPRAMs because many off-the-shelf FIFO queues perform pointer manipulation in hardware, thereby alleviating the need for a pointer scheduling frame. The window will have a size sufficient to accommodate a number of word transactions (whether they be input transactions, output transactions, or pointer transactions). The input scheduling frame and output scheduling frame can be together considered a data scheduling frame. The data scheduling frame will have a duration sufficient for a number of data transactions (whether they be input transactions or output transactions). The number of data transactions in the data scheduling frame can be any number greater than or equal to 1, and is preferably predetermined by a practitioner of the present invention. However, the present invention need not be limited to a data scheduling frame having a size sufficient for a number of word transactions that is predetermined, and may encompass data scheduling frames with a number of data transactions therein that are dynamically determined.

During the input scheduling frame of each window, words comprising the input direction traffic are given access to the bus. Once on the bus, those words can be passed to a data processor which performs some sort of processing upon the words. Typically, input queues (IQs) are used to interface the data processor and the input direction traffic coming from the bus. In such cases, when input direction traffic gets access to the bus, words will be written over the bus to IQs, where they will await processing by the processor.

During the output scheduling frame of each window, words comprising the output direction traffic are given access to the bus. These words are passed from the processor to an output stream via the bus. Typically, output queues (OQs) are used to interface the output data stream with the output direction traffic leaving the processor. In such cases, when output direction traffic gets access to the bus, words will be read over the bus from the OQs. Once read from the OQs, the words can be moved into the output data stream.

During the pointer scheduling frame of each window, pointer traffic is given access to the bus. The pointer traffic is necessary to keep track of pointer statuses in the IQs and OQs, so that subsequent writing operations and reading operations to the IQs and OQs will be useful.

Under one aspect of the present invention, the durations of the input scheduling frame and output scheduling frame within the data scheduling frame are dynamically allocated relative to each other as a function of the relative demand for the two types of traffic served during the input and output scheduling frames. If the state of the system is such that more input transactions are needed than output transactions for the time covered by a window, then the present invention will dynamically allocate more time within the data scheduling frame to the input scheduling frame than to the output scheduling frame. If the state of the system is such that more output transactions are needed than input transactions for the time covered by a window, then the present invention will dynamically allocate more time within the data scheduling frame to the output scheduling frame than to the input scheduling frame.

The present invention determines the relative demand for input direction traffic and output direction traffic by determining an input/output bias factor which is indicative of the demand. Preferably, an aggregate ingress queue (AIQ) will buffer the words comprising the input direction traffic that are waiting for bus access to get to the data processor. Also, an aggregate egress queue (AEQ) will preferably buffer the words comprising the output direction traffic that have just been taken off the bus and are awaiting transmission to a downstream device of some kind or outputting. The I/O bias factor can be determined by examining the relative occupancies of the AIQ and AEQ.

When both the AIQ and AEQ are fairly full, it would be desirable to favor writing data to the IQs (input transactions) over reading data from the OQs (output transactions) because there will be little or no space in the AEQ for storing data read from the OQs. However, there will be plenty of data in the AIQ that needs to be written to the IQs. When both the AIQ and the AEQ are fairly empty, it would be desirable to favor output transactions over input transactions because there will be plenty of space in the AEQ for storing data read from the OQs, and there will be little need to move data out of the AIQ given that it is fairly empty. When either the AIQ is fairly full and the AEQ is fairly empty or the AIQ is fairly empty and the AEQ is fairly full, there is no pressing need to favor either input transactions or output transactions. In fact, in such situations, a fairly even allocation of the input scheduling frame duration and the output scheduling frame duration is desirable. That is, when the AIQ is fairly full and the AEQ is fairly empty, data will need to be moved from the AIQ (to avoid possible blocking in the AIQ) and data will need to be moved from the OQs (to avoid possible blocking in the OQs). When the AIQ is fairly empty and the AEQ is fairly full, there will not be a pressing need to either move data to the AEQ (it is already fairly full) or move data from the AIQ (there is not much data there to move).

By making the I/O bias factor reflective of the AIQ and AEQ occupancies, the present invention can make intelligent decisions regarding how to allocate bus access between the input direction traffic and the output direction traffic, which helps reduce queue latency, possible queue blocking problems, and wasted bandwidth that may occur when little or no data needs to be written during an input scheduling frame or read during an output scheduling window.

Preferably, the input/output bias factor determination is arranged such that a large positive input/output bias factor favors input transactions, a large negative input/output bias factor favors output transactions, and as the input/output bias factor approaches zero, less favoritism is shown to either input transactions or output transactions. Of course, the input/output bias factor can be arranged to have a different scale (such as a large positive value favoring output transactions and a large negative value favoring input transactions, etc.)

To implement an input scheduling frame duration and an output scheduling frame duration reflective of the I/O bias factor, the present invention can calculate a target number of transactions for either the input scheduling frame or the output scheduling frame as a function of the I/O bias factor. Once a target number of transactions is known, the duration of the frames can be set such that there is a sufficient amount of time to perform those transactions over the bus.

To prevent an I/O bias factor at an extreme edge of favoring either input or output transactions from causing long delays for either input direction traffic or output direction traffic, the present invention also provides for the use of a bias damping factor to lessen the sway that the I/O bias factor causes on the relative durations of the input and output scheduling frames and maximum and minimum thresholds on the target number of transactions in either the input scheduling frame or the output scheduling frame.

Under another aspect of the present invention, a method is disclosed for intelligently arbitrating among the IQs to determine which IQs will receive input direction traffic during the input scheduling frames. For each IQ, a value representing its occupancy (how full it is) will be determined. Then, the selection of the IQ into which to write a data segment will be made according to the occupancy values of the IQs relative to a predetermined threshold occupancy value.

Preferably, for each data segment stored in the AIQ, a desired destination IQ will be determined therefor. Next, a comparison will be made between the occupancy value for the desired destination IQ and the predetermined threshold occupancy value. If the occupancy value for the desired destination IQ is less than the predetermined threshold occupancy value, then each word of the data segment will be written to the desired destination IQ. If the occupancy value for the desired destination IQ is greater than or equal to the predetermined threshold occupancy value, then each word of the data segment will be written to a different IQ having an occupancy less than the predetermined threshold occupancy value (if such an IQ exists). If no IQs have an occupancy value less than the predetermined threshold occupancy value, then the input scheduling window will be prematurely terminated, and the data segment will have to wait until a subsequent input scheduling window to be written to an IQ.

By not writing data segments to an IQ having an occupancy equal to or exceeding a predetermined threshold occupancy value, the present invention reduces the possibility of head-of-line blocking occurring in the IQs, and provides a fairly even distribution of words among the IQs. If the present invention allowed words to be written to a fairly full IQ when other IQs were fairly empty, the present invention would unnecessarily cause excessive queuing delays. That is, if IQ(A) has a 10 word wait before a processing element will queue the next word to be buffered therein, and IQ(B) only has a two word wait, then it would be desirable to buffer the next word in IQ(B) rather than IQ(A).

Under another aspect of the present invention, a method is disclosed for intelligently arbitrating how many output transactions should be assigned to a given OQ during the output scheduling frames. First, a non-empty OQ is selected. An occupancy value is then determined for the selected OQ. Next, a target number of output transactions for the selected OQ is determined as a function of the occupancy value for the selected OQ. The fuller the OQ is, the more output transactions will be assigned thereto. If the output scheduling frame has a duration sufficient to accommodate the determined target number of output transactions for the selected OQ, then the number of words read from that OQ during the output scheduling frame will be equal to the determined target number of output transactions for that OQ. If the output scheduling frame does not have a duration sufficient to accommodate the determined target number of transactions for that OQ, then words will be read from that OQ until the output scheduling frame terminates, and the remaining output transactions will be picked up in the next output scheduling frame.

Preferably, the non-empty OQs are selected in a round-robin fashion. By controlling the number of output transactions allocated to an OQ independent of the occupancy values of the other OQs, the present invention provides high scalability in that the number of OQs can be increased to a large value without increasing the computation complexity for the output scheduling frame. If the number of output transactions for the OQs are set according to the relative occupancies of all of the OQs, then the performance of the present invention would greatly decrease as more OQs (and more parallel processing elements) are added, because of the increased computations that would be required every output scheduling frame.

It is also preferable that the target number of output transactions for the selected OQ be determined as a function of a predetermined occupancy damping factor. To avoid a selected OQ with a large occupancy from hogging an entire output scheduling frame, an occupancy damping factor can be used to reduce the impact of the occupancy value in the determination of a target number of output transactions for the selected OQ. Similarly, it is also preferable to give each selected OQ a baseline number of output transactions. The target number of output transactions for the selected OQ can then deviate from the baseline number of output transactions as a function of the occupancy value for the selected OQ or as a function of both the occupancy value for the selected OQ and the occupancy damping factor.

In the present invention, it is preferable that the IQs and OQs are implemented as a plurality of dual port rams (DPRAMs). Each DPRAM may comprise at least one IQ and at least one OQ, preferably two IQs and two OQs. Each DPRAM preferably supports data flow between the queue manager and processor, wherein the queue manager and processor are in mutually asynchronous clock domains.

Stored within each DPRAM are at least two copies of an input read pointer (IRP) for each IQ implemented on the DPRAM, at least two copies of an input write pointer (IWP) for each IQ implemented on the DPRAM, at least two copies of an output read pointer (ORP) for each OQ implemented on the DPRAM, and at least two copies of an output write pointer (OWP) for each OQ implemented on the DPRAM. The IRP points to an address in the IQ where the next word to be provided to the processor is stored. The IWP points to the address in the IQ where the next word will be written to the IQ. The ORP points to an address in the OQ where the next word to be provided to the AEQ is stored. The OWP points to an address in the OQ where the next word will be written to the OQ.

Two copies of each pointer are used to prevent corrupted pointer read operations or pointer write operations from seriously affecting the input transactions and output transactions. For example, if a corrupt pointer were to infiltrate the system, an input transaction may overwrite a word still waiting to be read by the processor. Such pointer corruption may occur when the queue manager and the processor (which may be in mutually asynchronous clock domains) attempt to simultaneously access (either a read operation or a write operation) the same pointer. Because of the two pointer copies stored in the DPRAMs and the reading/writing configurations of the queue manager and the processor, corrupted pointers can be detected and not processed.

This can be explained as follows. Preferably, both copies are put in adjacent addresses in the DPRAM so that if the processor uses a microprocessor memory controller, that memory controller can burst read or burst write the two pointer copies. The queue manager can be configured to read or write both pointer copies backwards (i.e., copy two before copy one) while the processor can be configured to read or write both pointer copies forwards (i.e., copy one before copy two). While the reverse order can be used, it is preferable to have the processor read or write pointer copies forwards because most memory controllers can burst read or burst write only in the forward direction.

The queue manager writes two copies of the IWP for an IQ and the ORP for an OQ to the DPRAMs. The processor must be able to read those values. The processor writes two copies of the OWP for an OQ and the IRP for an IQ to the DPRMs. The queue manager must be able to read those values. By storing two copies of the pointers, and then having the queue manager and the processor perform their respective operations on the pointers in opposite directions, pointer corruption can always be detected. A pointer corruption can occur when the queue manager tries to write a pointer to the same address where a processor is trying to read a pointer, or when the queue manager tries to read a pointer from the same address where a processor is trying to write a pointer. Because the queue manager read/write operations move in one direction and the processor read/write operations move in the opposite direction, a state will not be achieved where both pointer copies are corrupted because both copies will never have both the queue manager and a processor accessing it at the same time given the divergent directions of the queue manager and processor operations. If only one copy is corrupted, the corruption can be detected because both of the read copies will not match.

When the queue manager updates its internal pointers that identify the pointer statuses in the DPRAMs by reading the IRP and the OWP, the queue manager will select a DPRAM, read both copies of the IRP and OWP stored therein, and then compare those copies against each other. If a match exists between the copies of the IRP (or OWP), the queue manager will update its internal IRP (or OWP) with the newly read pointer value. If matches do not exist, the queue manager will not update its internal pointers. Thus these non-matching pointers would be ignored and the processing will continue as if the read had not taken place, as is explained in greater detail in the description of the preferred embodiment.

The task of pointer updating occurs during the pointer scheduling frame. For every pointer scheduling frame, at least one pointer for at least one IQ or at least OQ will be updated. The task of pointer updating involves selecting an IQ and an OQ (preferably ones sharing a DPRAM), updating an internal IRP by reading the IRP of the selected IQ and updating an internal OWP by reading the OWP of the selected OQ. This procedure is performed as described above. Both copies of the IRP and OWP in the selected IQ and OQ are read and compared to determine whether a match exists. The internal pointers will be updated with the newly read pointers if matches exist. Also, the queue manager will overwrite the two copies of the IWP in the selected IQ and the two copies of the ORP in the selected OQ with its own internal value for those pointers. Preferably, in every pointer scheduling window, different IQs and OQs are selected for updating in a round robin fashion.

The present invention provides efficient allocation of time on the bi-directional data bus between input transactions and output transactions, arbitrates fairly among the IQs and OQs for access to the bi-directional data bus, and allows for the detection of corrupted pointers due to simultaneous pointer accesses.

These and other features and advantages of the present invention will be in part apparent, and in part pointed out, hereinafter.

### BRIEF DESCRIPTION OF THE DRAWINGS

FIG. 1 is a block diagram of the logical data flow topology showing a data stream separated into parallel paths for processing by processing elements and then merging back to a single path;

FIG. 2 is a block diagram of the realized topology of the logical topology depicted in FIG. 1;

FIG. 3 is a block diagram of a network processor implementing the realized topology of the present invention;

FIG. 4 is a block diagram of the input and output queues realized in dual-port random access memory and depicting pointer operations;

FIG. 5 is an example of memory arrangement in the DPRAMs along with a preferred arrangement of the pointers;

FIG. 6 is a chart of the possible read-write conflicts that can occur in a DPRAM while reading both copies of a pointer;

FIG. 7 is a block diagram of the hierarchy of schedulers in the queue manager;

FIG. 8 is a block diagram of the queue manager of the present invention;

FIG. 9(a) is a timing diagram of the main scheduler depicting how windows can be divided between the data scheduling frame and the pointer scheduling frame;

FIG. 9(b) is a timing diagram of the data scheduler depicting how data scheduling frames can be divided between the input scheduling frame and the output scheduling frame;

FIG. 9(c) is a timing diagram of the input scheduler depicting how input transactions can be allocated therein;

FIG. 9(d) is a timing diagram of the output scheduler depicting how output transactions can be allocated therein;

FIG. 9(e) is a timing diagram of the pointer scheduler depicting how pointer transactions can be allocated therein;

FIG. 10 is a flowchart depicting the operation of the data scheduler;

FIG. 11 is a flowchart depicting the operation of the input scheduler;

FIG. 12 is a flowchart depicting the operation of the output scheduler;

FIG. 13 is a flowchart depicting the operation of the pointer scheduler;

FIG. 14 is a graph of an allocation of input transactions in an input scheduling frame as a function of input/output bias, a maximum number of data transactions, and a bias damping factor;

FIG. 15 is a block diagram of the topology of the present invention wherein additional bidirectional data buses are used to interface the processing elements with the input queues and output queues.

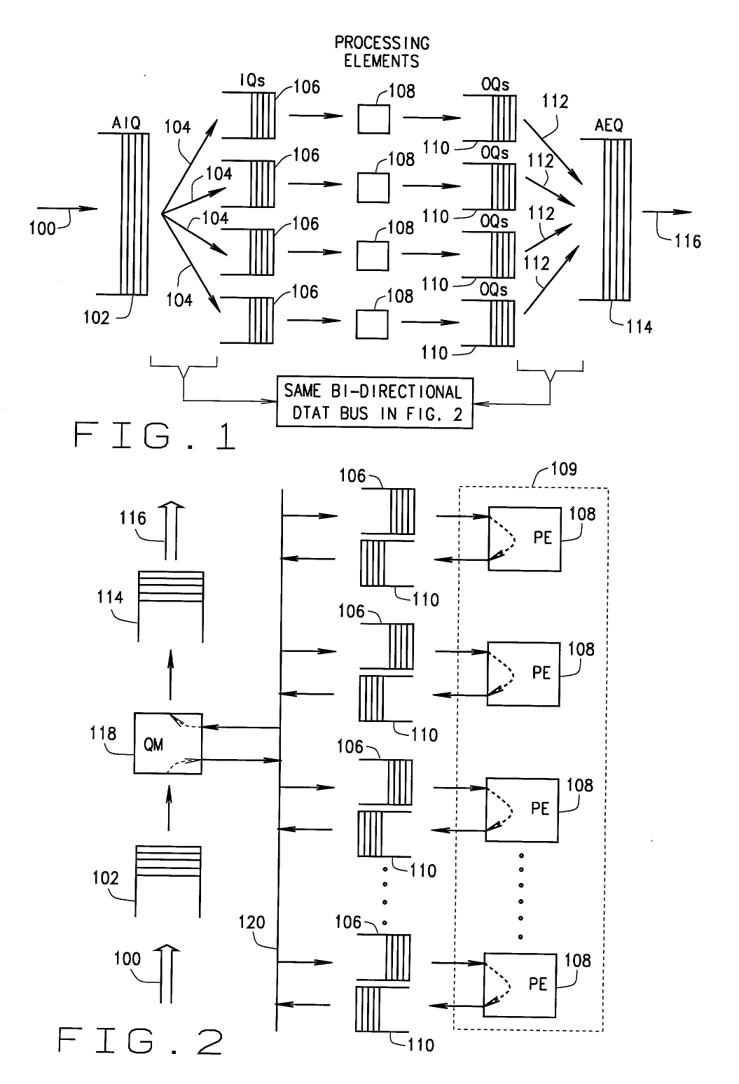

### DETAILED DESCRIPTION OF THE PREFERRED EMBODIMENTS

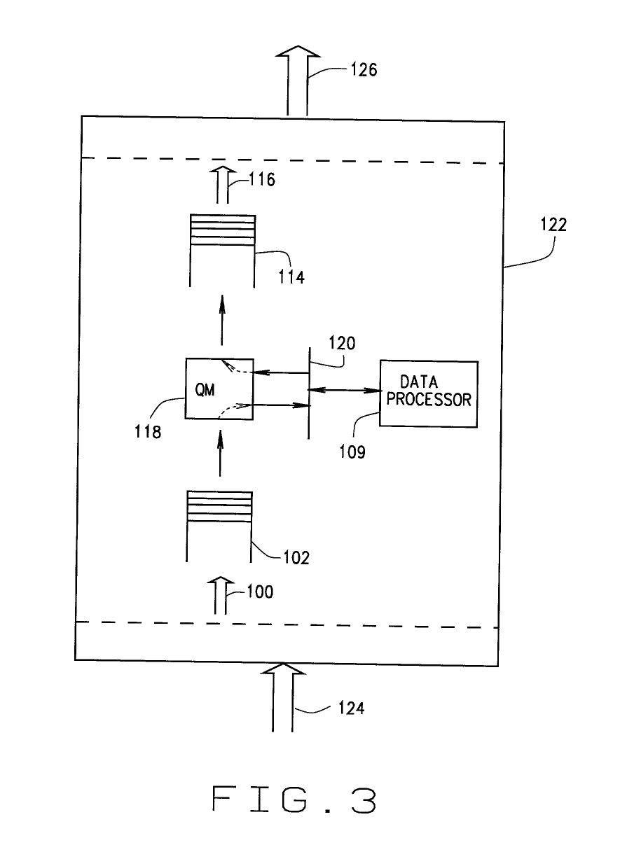

The present invention can be implemented in a network processor 122 that processes data between an input 124 and an output 126, as shown in FIG. 3. The network processor 122 can be any type of device that processes data packets transmitted across a network, for .example, a device for packet inspection, packet classification, packet switching, packet routing, traffic shaping, traffic policing, traffic prioritization, etc. At least some of the data received by the network processor will need to be processed by the data processor 109. A flow of data 100 in the network processor will be directed to the data processor 109 for processing. Data traffic entering the data processor can be considered input direction data traffic. Data traffic leaving the data processor can be considered output direction data traffic.

The input direction data traffic comprises a plurality of words that need to be processed by the data processor 109. The output direction data traffic comprises a plurality of words that have been processed by the data processor 109. As previously noted, a word of data preferably comprises 64 bits of data and 8 bits of parity (72 bits total). The words may together comprise a plurality of data segments, each data segment comprising at least one word. Data segments may have a fixed number of words (i.e., an ATM cell) or data segments may have a variable number of words (i.e., an IP packet).

In the present invention, a bi-directional data bus 120 is used to carry both the input direction traffic and the output direction traffic. A queue manager 118 serves to control access to the data bus 120 by arbitrating between the input direction data traffic heading for the data processor 109 over the data bus 120 and the output direction data traffic coming from the data processor 109 over the data bus 120. The queue manager is configured to arbitrate among the input and output traffic based upon a relative demand for bus access between the two types of traffic, as will be explained in more detail below.

An aggregate ingress queue (AIQ) 102 is preferably used to buffer the words comprising the input direction traffic that are waiting to get on the bus 120 and travel to the processor 109. An aggregate egress queue (AEQ) 114 is preferably used to buffer the words comprising the output direction traffic after traveling over the bus 120 from the processor 109.

The data processor 109 processes the words comprising the input direction traffic and sends the processed words back to the bi-directional data bus 109 as output direction traffic. The types of tasks that the data processor may perform are wide-ranging, and may be any of the above-mentioned processing tasks.

Preferably, a plurality of input queues 106 and output queues 110 interface the processor with the bi-directional data bus 120, as shown in FIG. 2. The data processor 109 can be implemented as a single device comprising a plurality of processing elements 108 that perform any of the above-mentioned tasks in parallel, each processing element receiving words from at least one input queue 106 and sending processed words to at least one output queue 110. The processor may also comprise a plurality of separate parallel processing elements 108 that together can be thought of as a logical processor 109.

A. Input Queue and Output Queue Implementations

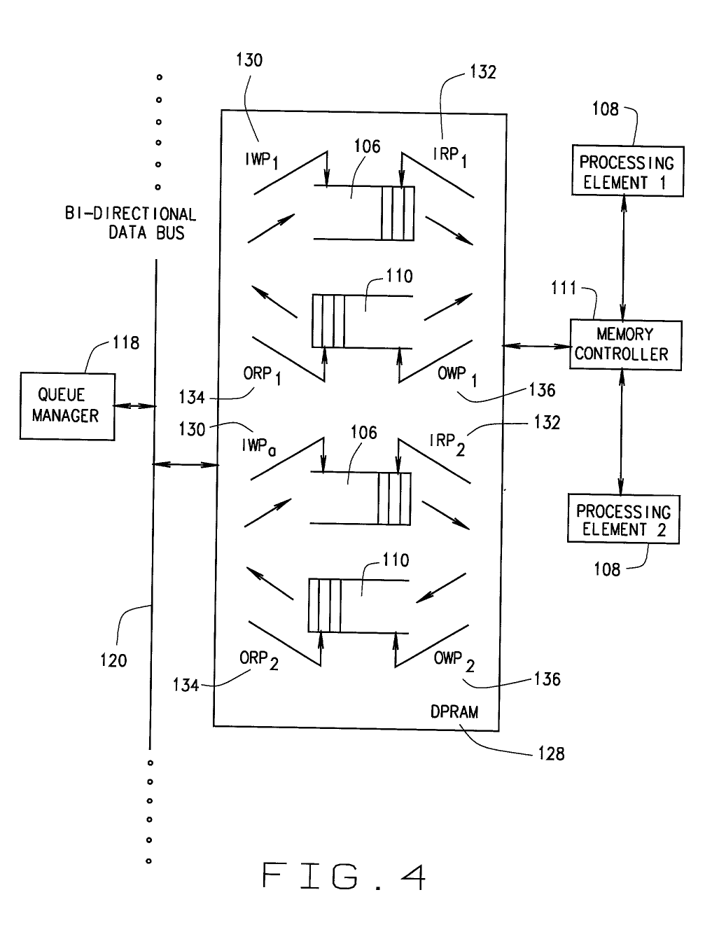

The plurality of input queues (IQs) 106 and output queues (OQs) 110 are preferably implemented on dual port RAM devices (DPRAMs) 128, as shown in FIG. 4. Each DPRAM 128 may comprise at least one IQ and at least one OQ, although in the preferred embodiment each DPRAM comprises two IQs and two OQs. The queue manager and processing elements linked on either side of the DPRAMs (by way of the bi-directional data bus) can be in mutually asynchronous clock domains. Also, each IQ and OQ is preferably a FIFO queue implemented as a circular buffer.

FIG. 4 depicts the interaction among the queue manager 118, a DPRAM 128, a processing element 108, and the bi-directional data bus 120. The DPRAM 128 shown in FIG. 4 comprises two IQs 106 and two OQs 110. The DPRAM 128 also stores pointer values for the IQs and OQs. These pointer values are needed to allow the queue manager and processing elements 108 to access the words stored therein. As shown in FIG. 4, each DPRAM maintains an input write pointer (IWP) 130 and an input read pointer (IRP) 132 for each input queue implemented thereon. Each DPRAM also maintains an output read pointer (ORP) 134 and an output write pointer (OWP) 136 for each output queue implemented thereon. It should be noted that when more than one IQ and QQ share the same DPRAM, the processing elements reading and writing to and from those IQs and QQs must share the same DPRAM. In such cases, a memory controller 111 can be used to collectively control the read/write accesses to the DPRAM from the processing elements sharing the DPRAM to prevent situations where both processing elements simultaneously access the DPRAM.

The IWP and OWP identify the address in the queue where the next word is to be written. The IRP and ORP identify the address in the queue from where the next word is to be read. The queue manager 118 writes the values of the IWP 130 and ORP 134 to the DPRAM 128. The processing element must be able to read those values. The processing element 108 writes the values of the OWP 136 and the IRP 132 to the DPRAM 128. The queue manager must be able to read those values.

One of the tasks of the queue manager is to write the words comprising the input direction traffic to the IQs 106. In doing so, the queue manager maintains an internal write pointer for each IQ. The internal write pointer identifies the address where the next word to be buffered in the queue should be written. Preferably, the internal write pointer for an IQ increments on each successive write operation to that IQ, and then wraps around once the highest queue address is reached. The words written to the IQ will be placed in incrementally increasing addresses (until the queue wraps around from its highest address back to its lowest).

When the queue manager updates an IWP value to the DPRAM, it overwrites the IWP value in the DPRAM with its latest internal write pointer value for that IQ. The processing element 108 does the same with the OWP and the OQ.

Another of the tasks of the queue manager is to read words comprising the output direction traffic from the OQs 110. In doing so, the queue manager maintains an internal read pointer for each OQ. The internal read pointer identifies the address from where the next word is to be read from the OQ. Preferably, the internal read pointer for an OQ increments on each successive read operation from that OQ, and then wraps around once the highest queue address is reached.

At some point after reading a word from an OQ, the queue manager needs update the ORP value in the DPRAM by overwriting the old ORP value with its latest internal read pointer value. The processing element 108 does the same with the IRP and the IQ.

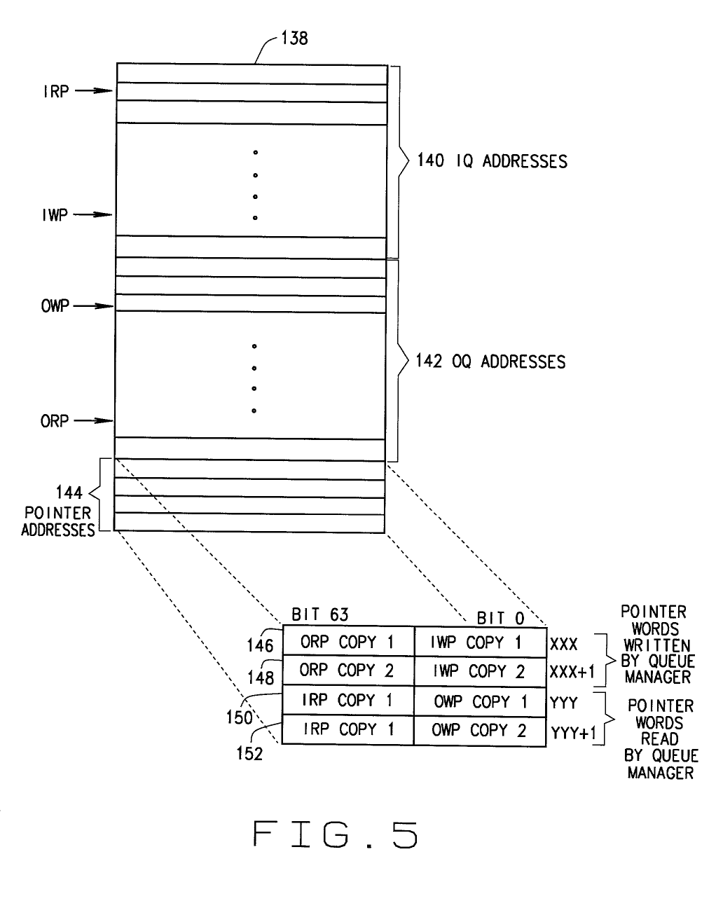

FIG. 5 depicts an example of how memory can be allocated in the DPRAM. The memory 138 comprises a plurality of addresses 140 set aside for an IQ 106, a plurality of addresses 142 set aside for an OQ 110, and a plurality of addresses 138 set aside for the pointers 130, 132, 134, and 136. If more than one IQ and OQ are implemented on the DPRAM, the addresses therein will be further divided to allow for the additional IQs and OQs. It is preferable that the pointers written by the queue manager for an IQ/OQ pair (IWP and ORP) be stored in the same word (at the same address), and that the pointers read by the queue manager for an IQ/OQ pair (OWP and IRP) be stored in the same word to minimize the memory accesses needed to read/write the pointer values. An IQ/OQ pair can be characterized as the IQ that feeds words to a processing element and the OQ that receives words from that same processing element. The word comprising the ORP and IWP can be called the egress pointer word. The word comprising the IRP and OWP can be called the ingress pointer word.

Thus, FIG. 5 depicts that the pointers ORP and IWP are both stored in the same address and that the pointers IRP and OWP are both stored in the same address. Two copies of the egress pointer word (146 and 148) are stored in the DPRAM as well as two copies of the ingress pointer word (150 and 152). It is also preferable that both copies of the egress pointer word and both copies of the ingress pointer word be stored in adjacent addresses in the DPRAM so they can be burst written or read by a microprocessor memory controller.

In FIG. 5, copy 1 of the egress pointer word 146 is stored at address XXX in the DPRAM and copy 2 of the egress pointer word 148 is stored at address XXX+1 in the DPRAM. Also, copy 1 of the ingress pointer word 150 is stored at address YYY in the DPRAM and copy 2 of the ingress pointer word 152 is stored at address YYY+1 in the DPRAM.

Both the queue manager and processing element to which the IQ and OQ are linked need to access each of the pointers stored in the DPRAM. The queue manager must write the IWP and a processing element must read the IWP. Also, the queue manager must write the ORP and a processing element must read the ORP. Similarly, a processing element must write the OWP and the queue manager must read the OWP, and a processing element must write the IRP and the queue manager must read the IRP.

Because both the queue manager and the processing elements need to access the same pointers, conflicts can exist when the queue manager and a processing element attempt to access the same pointer at the same time. Such a conflict can cause a pointer corruption because when a pointer is read while it is being written, the read pointer value may be some unintelligible combination of the old pointer value and the new pointer value. To prevent such pointer corruption from causing the queue manager or processing element to misread a pointer and overwrite data using the misread pointers, the present invention provides that two copies of each pointer value be stored in the DPRAM.

When the queue manager writes the IWP and the ORP, it writes two copies of the egress pointer word to the DPRAM. When the queue manager reads the IRP and the OWP, it reads two copies of ingress pointer word from the DPRAM. When a processing element writes the IRP and OWP to the DPRAM, it replaces both old copies of the egress pointer word with two new copies of the egress pointer word. When a processing element reads the ORP and IWP from the DPRAM, it reads both copies of the ingress pointer word. By configuring the queue manager and the processing element to perform their respective read/write operations in the opposite directions, the present invention prevents the queue manager and a processing element from accessing both copies of a pointer word at the same time.

Preferably, the queue manager will read or write the copies backwards (copy 2 before copy 1) while a processing element will read or write the copies forwards (copy 1 before copy 2). It is preferable that the processing elements read/write in the forward direction because many microprocessor memory controllers can only burst read or write in the forward direction. While one copy may be corrupted because of a simultaneous access, the other copy will not experience a simultaneous access because of the divergent directions of the respective operations of the queue manager and the processing elements. Essentially, if the queue manager and processing element are simultaneously accessing copy 1 of a pointer, the queue manager will have already accessed copy 2, while the processing element will not access copy 2 until the next access. If the queue manager and processing element are simultaneously accessing copy 2, then the processing elements will have already accessed copy 1 while the queue manager will not access copy 1 until the next access.

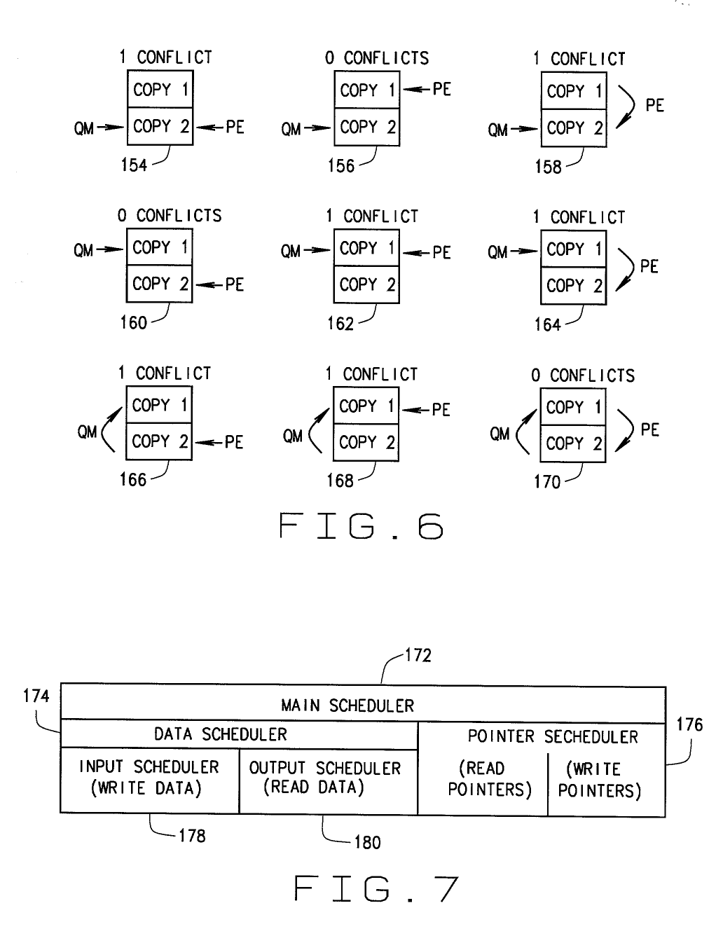

FIG. 6 depicts a chart of the possible read-write conflicts that can occur in a DPRAM while reading both copies of a pointer. There are four states that the queue manager or a processing element can be in at any moment: 1) it is doing nothing with the pointers in the DPRAM; 2) it is accessing the first copy of the pointers in the DPRAM; 3) it is accessing the second copy of the pointers in the DPRAM; and 4) it is in between accessing the first copy and the second copy, which is conservatively counted as accessing both copies simultaneously. The first state can be eliminated from a conflicts analysis because no conflict can occur if either the queue manager or processing element is doing nothing with the pointers. Of the three remaining states, there are total of nine possible combinations, as shown in FIG. 6. In the cases shown in FIG. 6, the arrow on the left hand side of the copies represents a read/write operation by the queue manager and the arrow on the right hand side of the copies represent a read/write operation by a processing element.

In case 154, a conflict occurs when the queue manager and a processing element attempt to access copy 2 of the pointer word at the same time. That access will presumably result in a misread pointer. However, on the next access, both copies of the pointer word will not be misread because the processing element will have already accessed copy 1 and the queue manager will not access copy 1 until later. Therefore, the corruption of copy 2 can be detected by comparing the misread copy 2 with the properly read copy 1; if a pointer is corrupted, copy 1 will not match copy 2.

When the corruption is detected, either the queue manager or the processing elements can treat its read operation as never occurring and not update its internal pointer values with the non-matching pointers. While maintaining an old pointer is not optimal for system performance, the system can recover by reading the pointer on a subsequent attempt. However, if the corruption went undetected and the misread pointer entered the system, data could be lost as words are written to the wrong addresses and are read from the wrong addresses.

Returning to FIG. 6, case 156 is a case where no conflicts exist. The queue manager is accessing copy 2 and the processing element is accessing copy 1. On a subsequent access, the queue manager will access copy 1 while the processing element will access copy 2. Presumably, no pointer corruption will occur.

In case 158, one conflict will occur when the queue manager accesses copy 2 while the processing element transitions from copy 1 to copy 2. The diverging directions of the queue manager and the processing element will prevent both copies from being corrupted, and the corruption of copy 2 can be detected.

Case 160, which is similar to case 156, is a case where no conflicts exist. Case 162, which is similar to case 154, is case where one conflict will occur, but two conflicts will not occur, and the corruption can be detected. Cases 164, 166, and 168 are similar to case 158 and are examples where only one conflict will occur. Case 170 shows the queue manager moving to access copy 1 while the processing element is moving to access copy 2; here no conflicts will occur.

Thus, it can be shown that two conflicts will never occur when read/writing the pointer copies, meaning that the pointer corruption due to simultaneous accesses can always be detected. This synchronization scheme with memory-mapped pointers allows the implementation of at least one IQ and at least one OQ in the DPRAMs without the use of external semaphore signals or external synchronization circuits.

As will be explained in more detail below, the present invention involves periodically updating the pointer values in the DPRAMs during a pointer scheduling frame. Because it is possible for a significant amount of delay to exist between pointer updates between the entities, there may be a question as to whether the system can track pointers in a delayed manner without causing data overruns. However, it can be shown that the queue manager never treats an IQ as less full than it actually is (so the queue manager will not write new words over words still waiting to go to the processing element) and that each processing element never treats an IQ as more full than it actually is (so the processing element will not read empty words (or already-read words) from the IQs. The same situation holds true for the OQs, the queue manager will not treat an OQ as more full than it actually is and the processing elements will not treat an OQ as less full than it actually is.

The last-known occupancy of a queue (representing how full the queue is) can be calculated as follows:

$$\begin{matrix}queue occupancy = WP - RP ; if WP \geq RP \\ = WP - RP + queue capacity ; if WP < RP\end{matrix} \qquad ( 1 )$$

WP represents the last known write pointer for that queue, RP represents the last known read pointer for that queue, and the queue capacity represents the number of addresses for storing words in the queue. When the write pointer value is larger than or equal to the read pointer value, (WP−RP) represents the occupancy of the queue (how many words are stored therein that still need to be read out). When the write pointer value is less than the read pointer value, then (WP−RP) represents the vacancy of the queue (how many addresses are available for storing new words). Once the vacancy of the queue is known, the occupancy of the queue can be found by adding the vacancy to the queue capacity (the vacancy will be a negative number).

The queue manager knows the actual values for the IWP and the ORP for each IQ (it controls the writing of those values). However, the IRP and OWP values that the queue manager knows may not represent the current status of the IQ or the OQ (due to updating delays). Similarly, the processing elements know the actual values for the OWP and the IRP, but the ORP and the IWP values it knows may not represent the current status of the IQ or the OQ. However, this uncertainty will not cause data overruns.

No pointers ever decrease, except when they wrap around by the size of the queue. Thus, from the perspective of the queue manager, the last-known IRP for an IQ is always less than or equal to the actual IRP for that IQ, and the last known OWP for an OQ is always less than or equal to the actual OWP for that OQ.

It follows then that the queue manager will never treat an IQ as less full than it actually is and will never treat an OQ as more full than it actually is. This same result holds true from the perspective of the processing elements. Because the queue manager never treats an IQ as less full than it actually is, the queue manager will not overwrite words in an IQ that still need to be read by a processing element. Likewise, because a processing element never treats an OQ as less full than it actually is, the processing element will not overwrite words in an OQ that still need to be read by the queue manager. Also, because the queue manager never treats an OQ as more full than it actually is, the queue manager will not spend time reading from addresses in an OQ that do not have words stored therein needing to be read. Likewise, because a processing element never treats an IQ as more full than it actually is, the processing element will not spend time reading from addresses in an IQ that do not have words stored therein needing to be read.

As long as there seems to be something in a queue, system performance will not suffer from delayed updates of pointers. That is, as long as pointers are updated before the observed occupancy becomes empty, system performance will not suffer at all. In practice, delayed pointer updates rarely affect system performance, because, as will be explained in more detail below, under light loads, pointers will be updated frequently and any residual penalty is small. Under heavy loads, the IQs and OQs will be more full, allowing more time for pointers to update before the queues become empty.

B. Queue Manager

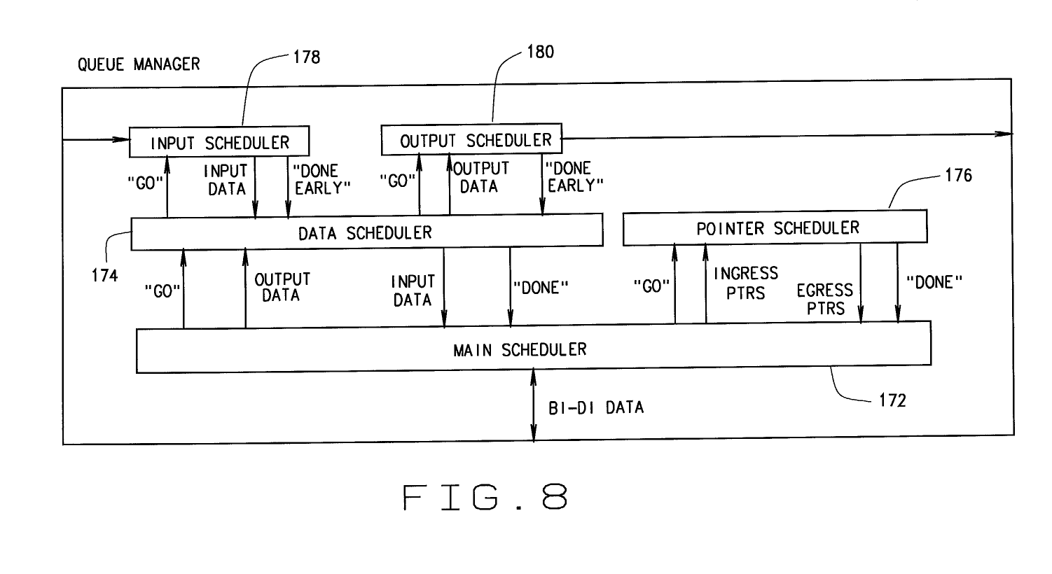

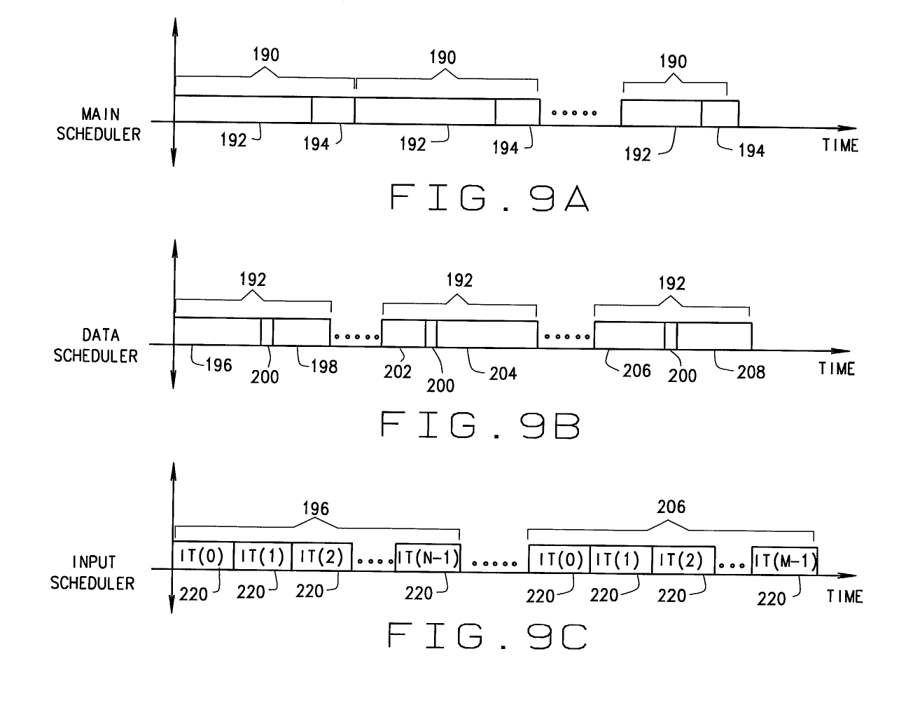

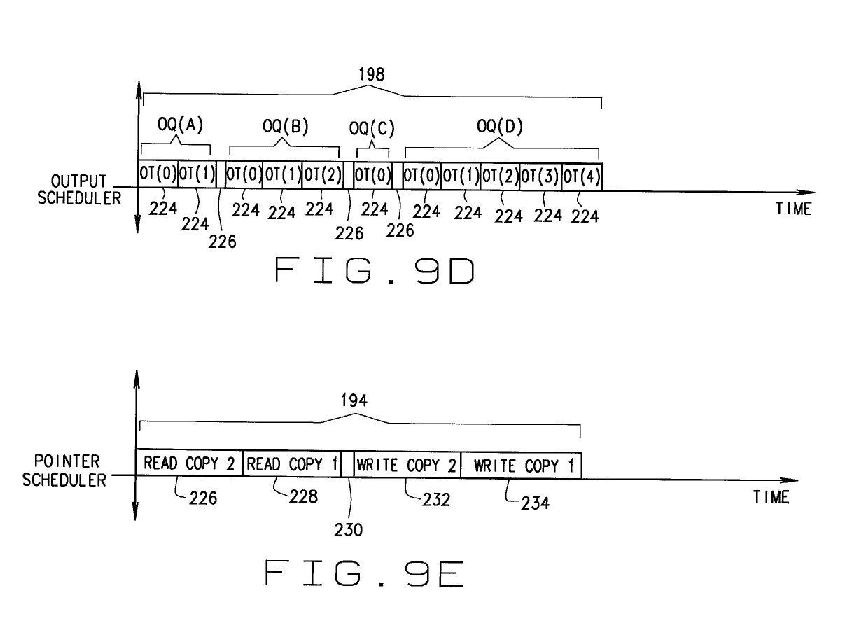

The queue manager of the present invention comprises five schedulers: a main scheduler, a data scheduler, a pointer scheduler, an input scheduler, and an output scheduler. FIG. 7 depicts an overview of the scheduler hierarchy. The schedulers control queue manager operations for windows of time. As shown in FIGS. 7 and 8, the main scheduler 172 controls the data scheduler 174 and the pointer scheduler 176. The data scheduler 174 controls the input scheduler 178 and the output scheduler 180. FIGS. 9(a) through 9(e) depict timing diagrams for the various schedulers. Attached as Appendix A is a copy of the software code that can be used by the queue manager in implementing the various schedulers.

B.1: Main Scheduler

The main scheduler 172 controls a plurality of windows of time 190, shown in FIG. 9(a). Each window 190 comprises the time on the data bus when access to the data bus will be allocated between input transactions (words being written to the IQs for subsequent processing by a processing element), output transactions (words being read from the OQs), and pointer transactions (updating pointer values for the IQs and OQs). The main scheduler allocates time on the bus between data transactions (both input and output transactions) and pointer transactions. The time on the bus that the main scheduler allocates to data transactions can be called a data scheduling frame 192. Each window 190 will have a data scheduling frame 192. The time on the bus that the main scheduler allocates to pointer transactions can be called a pointer scheduling frame 194. Each window 190 will have a pointer scheduling frame 194. During each data scheduling frame, the main scheduler gives control of the data bus to the data scheduler 174. During each pointer scheduling frame, the main scheduler gives control of the data bus to the pointer scheduler 176.

The duration of the window 190 can be varied by a practitioner of the present invention to meet the particular needs of the system in question. In their preferred embodiment, the inventors herein have set the window size to be 250 cycles. The main scheduler will set the duration of the data scheduling frame 192 such that there is a sufficient amount of time in the data scheduling frame to perform a number of data transactions. A remainder of the window 190 can be allocated to the pointer scheduling frame 194. A data transaction can be defined as writing a word to an IQ over the bi-directional data bus (an input transaction) or reading a word from on OQ over the bi-directional data bus (an output transaction).

The number of data transactions in the data scheduling frame can be any number greater than or equal to zero (zero data transactions would occur if the queue manager had no data to send/receive). The exact number of data transactions in a data scheduling frame is set after determining a trade-off between bandwidth and latency. If the number of data transactions during a window is reduced, then the number of pointer transactions should be increased. However, pointer transactions are overhead and therefore reduce the system's effective bandwidth. The trade-off arises because pointer updates are needed to maintain low latency for the system.

A pointer transaction can be defined as writing an egress pointer word to a DPRAM or reading an ingress pointer word from a DPAM. It is preferable that at least one IQ and one OQ have its pointers updated every pointer scheduling frame. A pointer update involves for an IQ and OQ involves writing a new IWP and ORP value to the DPRAM including that IQ and OQ and reading a new IRP and OWP value from the DPRAM including that IQ and OQ. Four pointer transactions are preferable so that both copies of an egress pointer word can be written to a DPRAM and both copies of an ingress pointer word can be read from a DPRAM.

Preferably, the number of data transactions for the data scheduling frame is predetermined by a practitioner of the invention. However, the invention is not limited to such cases, and may include data scheduling frames which include a number of data transactions that are dynamically determined.

B.2: Data Scheduler

The data scheduler 174 controls both the input scheduler 178 and the output scheduler 180. Every data scheduling frame 192 is dynamically divided into an input scheduling frame and an output scheduling frame. Thus, in any given data scheduling frame 192, the durations of the input scheduling frame and output scheduling frame may vary. Input transactions over the data bus occur during the input scheduling frames. An input transaction comprises writing a word to an IQ. Output transactions over the data bus occur during the output scheduling frames. An output transaction comprises reading a word from an OQ.

FIG. 9(b) is a timing diagram depicting three data scheduling frames 192 that have been divided into an input scheduling frame and an output scheduling frame. The leftmost data scheduling frame 192 has been divided into an input scheduling frame 196 and an output scheduling frame 198. Wait cycles 200 have been inserted between the two frames to eliminate the possibility of collisions occurring on the bus at the transition from input direction traffic and output direction traffic. The next data scheduling frame 192 has been divided into an input scheduling frame 202 and an output scheduling frame 204. As can be seen, input scheduling frame 202 has a different duration that input scheduling frame 196. Likewise, output scheduling frame 204 has a different duration than output scheduling frame 198. The rightmost data scheduling frame 192 is also divided into an input scheduling frame 206 and an output scheduling frame 208, with a wait cycle 200 inserted therebetween.

The sizes of an input scheduling frame and output scheduling frame within the same data scheduling frame relative to each other is dynamically controlled by the data scheduler 174 as a function of whether the system should favor using the bi-directional data bus to transfer words to be written to the IQs (input transactions) or to transfer words read from the OQs (output transactions).

The data scheduler 174 determines an input/output bias factor for the bi-directional data bus to indicate whether the system should favor input transactions or output transactions. The I/O bias factor is indicative of a relative demand for bus access between input direction traffic (input transactions) and output direction traffic (output transactions). Using the I/O bias factor, the data scheduler sets the durations of the input and output scheduling frames.

By dynamically allocating access to the bus between input direction traffic and output direction traffic as a function of a relative demand for bus access between the two traffic types, the present invention optimizes traffic movement across the bus and provides an orderly flow to data traffic that minimizes data overrun possibilities and unnecessary queuing delays.

Preferably, the I/O bias factor is determined as a function of the occupancies of the AIQ and AEQ. The occupancies of the AIQ and AEQ can be supplied to the queue manager by the controllers for the AIQ and AEQ. Having determined occupancy values for the AIQ and AEQ, the data scheduler can calculate the I/O bias factor according to the formula:

I/O Bias=(AIQ occupancy+AEQ occupancy)−(AIQ capacity+AEQ capacity)/2 (2)

Under this formula, the I/O bias factor can range from negative values to positive values. The larger positive the I/O bias factor is, the more advantageous it will be to favor input transactions because a large positive value indicates that both the AIQ and AEQ are fairly full. When both the AIQ and AEQ are fairly full, there are plenty of words to be moved from the AIQ to the IQs, and there is little space in the AEQ for words coming from the OQs. Thus, it is desirable in this case to allocate more time during the data scheduling frame to input transactions.

The larger negative the I/O bias factor is, the more advantageous it will be to favor output transactions because a large negative value indicates that both the AIQ and AEQ are fairly empty. When both the AIQ and AEQ are fairly empty, there is little need for a large number of input transactions because there are relatively few words in the AIQ to move to the IQs. However, there is plenty of space in the AEQ in which to move words from the OQs. Thus, it is desirable in this case to allocate more time during the data scheduling frame to output transactions.

As the I/O bias factor approaches zero, little advantage is gained from favoring either input transactions or output transactions because when the I/O bias factor is near zero, either the AIQ or AEQ will be fairly full and the other will be fairly empty. When the AIQ is fairly full and the AEQ is fairly empty, little would be gained by favoring one transaction type over the other because both types of transactions are needed. Likewise, when the AEQ is fairly empty and the AEQ is fairly full, little would be gained by favoring one transaction type over the other because neither transaction type is especially needed.

Thus, when the durations of the input scheduling frame and output scheduling frame are set as a function of the I/O bias factor, a large positive bias factor will result in the input scheduling frame being larger than the output scheduling frame, a large negative bias factor will result in the output scheduling frame being larger than the input scheduling frame, and as the bias factor approaches zero the durations of the input scheduling frame and the output scheduling frame will approach the same length.

To translate the determined I/O bias factor into an actual frame size, the present invention preferably calculates a target number of input transactions for the input scheduling frame as a function of the I/O bias factor and the number of data transactions that will fit in the data scheduling frame. Once the target number of transactions for the input scheduling frame is determined, the duration of the input scheduling frame can be set to accommodate that target number of input transactions. A remainder of the data scheduling frame can be assigned to the output scheduler.

Of course, it should be appreciated that the present invention can also set the input/output scheduling frame sizes by determining a target number of output transactions as a function of the I/O bias factor and number of data transactions for the data scheduling frame, then setting the duration of the output scheduling frame to accommodate the target number of output transactions, and then giving a remainder of the data scheduling frame to the input scheduler.

An additional factor in the calculation of a target number of input transactions can be a bias damping factor. The bias damping factor defines a proportional relationship between the I/O bias factor and number of input transactions and output transactions that are assigned, and can be used to lessen the impact that the I/O bias factor has on the relative durations of the input scheduling frame and the output scheduling frame. It may be desirable to avoid overly favoring either input transactions or output transactions to prevent starving the AEQ (when the number of input transactions is much larger than the number of output transactions) or starving the IQs (when the number of output transactions is much larger than the number of input transactions).

For example, when the AIQ is fairly full, and the AEQ is empty, the I/O bias factor will become a large positive value and input transactions will be favored over output transactions during the data scheduling frame, as explained above. However, some moderation is needed in determining the favoritism given to input transactions, because if little or no output transactions occur during the output scheduling frame, then the AEQ will remain empty on subsequent windows. When the AEQ remains empty for subsequent windows, the I/O bias factor will continue to likely favor input direction traffic, especially if the AIQ remains fairly full as input data continues to arrive therein.

Thus, a situation may occur where output direction traffic is starved. When the AEQ is starved, little or no words will be leaving the OQs while new words are being added thereto by the processing element. This may at least result in long delays for the words in the OQs, and may possibly result in word overruns as the OQ capacities are exceeded. To give the AEQ a chance to recover, it is desirable to moderate the effect that the input bias has on the relative allocation of input transactions and output transactions.

To achieve a balance in structuring the data flow to represent the relative demand for input transactions and output transactions on the bus while still maintaining achieving good throughput for output direction traffic, a practitioner of the present invention can set the bias damping factor to be a value that strikes a balance between relative demand for bus access and maintaining throughput for the system.

Additionally, for the same reason that the bias damping factor is used, a maximum number of input transactions and a maximum number of output transactions can be set for the input scheduling frame and the output scheduling frame.

The target number of input transactions for the input scheduling frame can be calculated according to the formula:

IT target=(# DTs/2)+(I/O bias*bias damping factor) (3)

In this equation, “IT target” represents the target number of input transactions for the input scheduling frame, “# DTs” represents the number of data transactions available in the data scheduling frame, “I/O bias” represents the I/O bias factor determined according to formula 2, and the “bias damping factor” represents a value that is preferably predetermined by a practitioner of the present invention.

It follows from this equation that the target number of output transactions for the output scheduling window will be the number of data transactions for the data scheduling window minus the target number of input transactions.

Equation 3 allows for a strict 50% time allotment on the data bus between input direction traffic and output direction traffic when either the I/O bias factor calculated according to formula 2 is zero or the bias damping factor is set to zero. Also, equation 3 allows a practitioner of the present invention to adjust the time allotment on the data bus between input direction traffic and output direction traffic by adjusting the bias damping factor. By incorporating maximum and minimum values on the result of equation 3, the present invention can prevent situations from occurring where the I/O bias factor remains at one end of the spectrum, and thereby starves either the input direction traffic or the output direction traffic. Also, equation 3 provides very low computation complexity. It does not factor in the occupancies of the IQs and OQs when determining how words should be written thereto or read therefrom. Only the AIQ and AEQ occupancies need to be evaluated. By not considering the IQ occupancies and OQ occupancies, the present invention allows the system to be scaled to include larger numbers of IQs and OQs without increasing the time needed to perform calculations during the data scheduling frame.

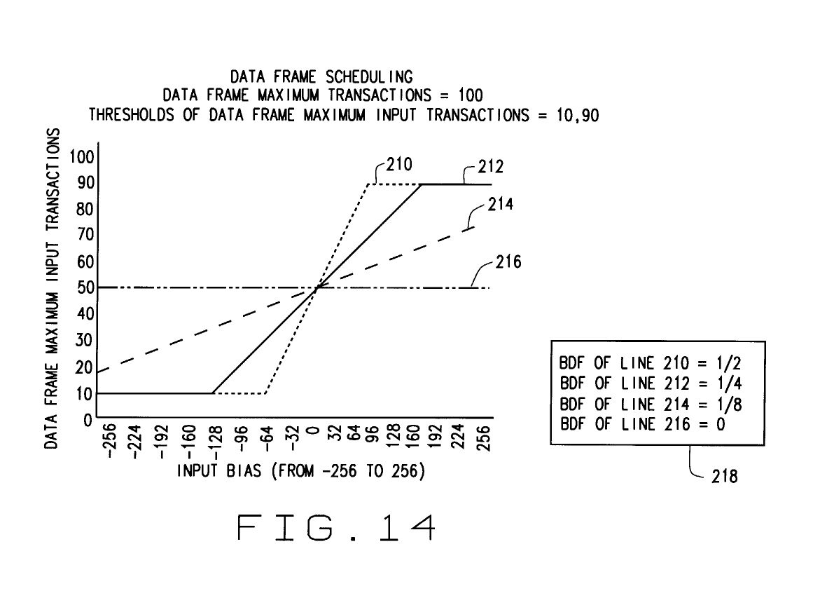

FIG. 14 is a graph of an allocation of input transactions in an input scheduling frame as a function of input/output bias, a number of data transactions available in the data scheduling frame, and a bias damping factor. As can be seen in FIG. 14, a threshold for the maximum number of input transactions has been set at 90. The number of data transactions available in the data scheduling window is set at 100. Thus, the minimum number of input transactions is 10.

FIG. 14 shows four plots 210, 212, 214, and 216, each plot signifying a different bias damping factor, as noted in the legend 218. When the bias damping factor is zero, the I/O bias factor does not affect how the input scheduling frame and output scheduling frame are allocated; each will be allocated 50% of the data scheduling frame (plot 216). However, as the bias damping factor increases, the I/O bias factor will have more and more of an effect on the relative sizes of the input scheduling frame and the output scheduling frame (see the increasing slopes of plots 214, 212, and 210 respectively). The maximum and minimum values for the target number of input transactions cap the plots at either end of the bias spectrum.

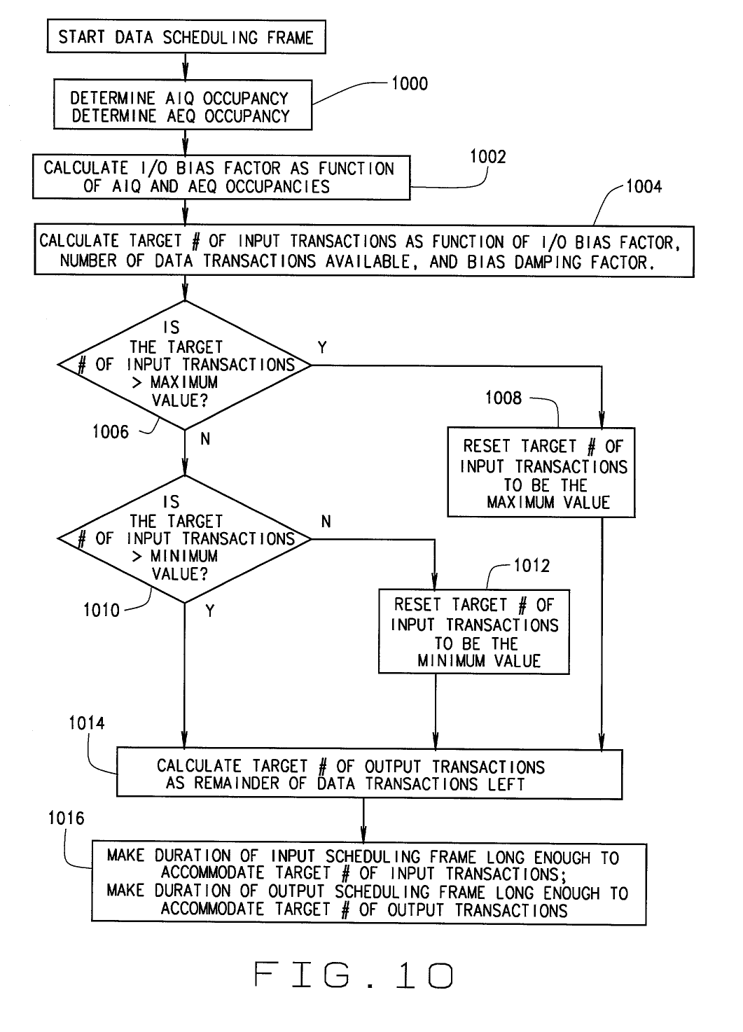

FIG. 10 depicts a flowchart for the data scheduler. At step 1000, the occupancies for the AIQ and AEQ are determined (these values will be supplied to the queue manager by controllers for the AIQ and AEQ, as previously explained). Next, at step 1002, the I/O bias factor is calculated as a function of the AIQ and AEQ occupancies according to formula 2. Then at step 1004, the data scheduler calculates a target number of input transactions for the input scheduling frame according to formula 3. At step 1006, the data scheduler checks whether the target number of input transactions is greater than a predetermined maximum threshold number of input transactions. If so, then the target number of input transactions is reset to equal the predetermined maximum threshold number of input transactions (step 1008). If not, then the data scheduler checks whether the target number of input transactions is greater than a predetermined minimum threshold number of input transactions (step 1010). If not, then the target number of input transactions is reset to equal the predetermined minimum threshold number of input transactions (step 1012). If so, the data scheduler proceeds to step 1014 where it calculates a target number of output transactions for the output scheduling frame as the remainder of data transactions left in the data scheduling frame. The data scheduler will also reach step 1014 from steps 1008 and 1012. Then, from step 1014, the data scheduler will proceed to step 1016 where the duration of the input scheduling frame is set to be large enough to accommodate the target number of input transactions and the duration of the output scheduling frame is set to be large enough to accommodate the target number of output transactions.

When the data scheduler passes control of the bus to the input scheduler during the input scheduling frame and to the output scheduler during the output scheduling frame, the input scheduler and the output scheduler do not need to have any knowledge of the number of transactions that have been allotted to them. To maintain the timing schedule set by the main scheduler, the data scheduler will pre-emptively interrupt the input and output schedulers when their allotted frames end, whether or not they have completed their allotted number of transactions. During the subsequent window, the data scheduler will restart the input and output schedulers with no cooperation on their part. This simplifies the scheduling algorithms of the input scheduler and the output scheduler because they can schedule events that are much larger or smaller than their allocated time in the data scheduling window.

B.3: Input Scheduler

The input scheduler 178 performs the writing of words to the IQs over the bi-directional data bus during the input scheduling frame. The duration of the input scheduling frame will be set by the data scheduler as explained above such that the input scheduler has sufficient time to complete the target number of input transactions determined for the input scheduling frame.

FIG. 9(c) is a timing diagram depicting how the input transactions can be allocated during the input scheduling frame. During input scheduling frame 196, there are N input transactions 220. During a subsequent input scheduling frame 206, M input transactions 220 can be seen.

One of the main tasks of the input scheduler is to send the input transactions to an appropriate IQ. In doing so, the present invention achieves a relatively even distribution of words among the IQs that reduces the amount of delay experienced by a word on its way to a processing element because input transactions will not be written to IQs filled beyond a threshold occupancy. Further, the present invention sends each word of a data segment to the same processing element by writing all of the words comprising a data segment to the same IQ.

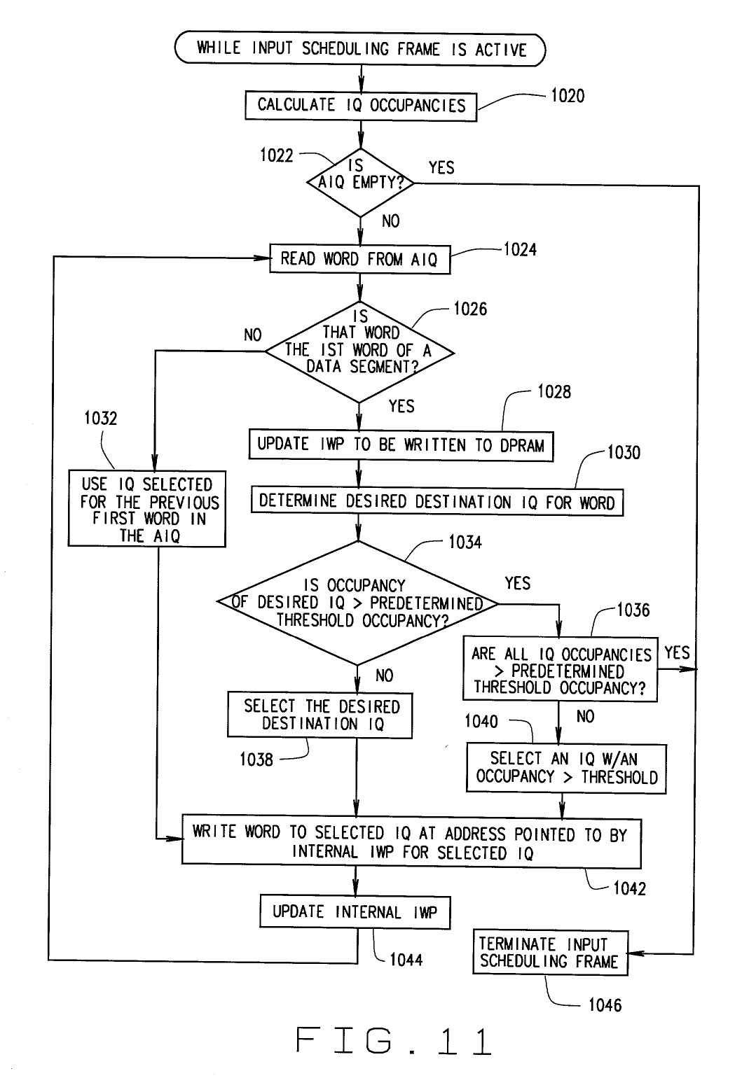

FIG. 11 depicts a flowchart for the operation of the input scheduler. Preferably, the input scheduler will know occupancy values for all of the IQs. The occupancy value of each IQ can be calculated according to formula 1 described above (step 1020). At step 1022, the input scheduler will determine whether the AIQ is empty by checking whether its AIQ occupancy value is zero. If the AIQ is empty, the input scheduler will terminate the input scheduling frame prior to the end of its planned duration (step 1046). The input scheduling frame terminates if the AIQ is empty because when the AIQ is empty, no words need to be moved to the IQs. By prematurely terminating the input scheduling frame and returning the bus to the data scheduler (which will in turn start the output scheduling frame), the present invention avoids setting aside bus time for no activity.

If the AIQ is not empty, then the input scheduler proceeds to step 1024 and reads a word in the AIQ. Preferably, the read word will be the word pointed to by the queue manager's internal AIQ read pointer. At step 1026, the input scheduler will check whether that word is the first word of a data segment. A flag in the word will identify whether the word is the first word of a data segment. If there is no flag in the first word identifying it as such, other known methods can be used to determine whether the word is the first word of a data segment, such the use of a framer to make the determination by pattern-matching. If the word is the first word of a data segment, at step 1028, the input scheduler will update the IWP value to be written to the DPRAM with its current internal IWP value minus one. By notifying the DPRAM of pointers only to data segment boundaries, the present invention can prevent fragmentation of data segments. Also, the pointer seen by the DPRAM should be a pointer to the last word of a data segment so that the full length of the data segment in the IQ can be known.

Next, at step 1030, the input scheduler will determine a desired destination IQ for the data segment of which the first word is part. A field in the first word will have a PE identifier that identifies the PE to which the segment should go. Once this PE is determined, the desired destination IQ for each word of the segment is the IQ associated with that PE. At this time, the input scheduler will also determine a word length for that data segment. The desired destination IQ and the word length for the data segment can be determined from reading the first word by checking information in the field of the first word It is advantageous to send the words of a data segment to the appropriate IQ (and thus the appropriate PE) because some PEs may be more suited to process particular data segments. If step 1026 determines that the word is not a first word of a data segment, then this means that an IQ for the data segment of which that word is a part has been previously selected. In such cases, the input scheduler will proceed to step 1032 and retrieve the stored selected IQ for the data segment.

From step 1030, the input scheduler proceeds to step 1034, where the occupancy of the desired destination IQ is compared to a predetermined threshold maximum occupancy value. If the occupancy of the desired destination IQ equals or exceeds the threshold maximum occupancy value, then the input scheduler will select a different IQ to which to write the word (steps 1036 and 1040). This process is called segment redirection. Segment redirection can be implemented in either of two ways: (1) each word of the segment can be stored in a random IQ that passes the occupancy threshold test, or (2) each word of the segment can be stored in an IQ specifically designated for receiving redirects (and if that IQ is overly full, then to a second designated IQ). If the occupancy of the desired destination IQ is less than the threshold maximum occupancy value, then the input scheduler will select the desired destination IQ as the IQ to which to write the data (step 1038). In the preferred embodiment, the threshold maximum occupancy value is set to be about ¾ of the IQ capacity. However, a practitioner of the present invention, can vary this value to meet the needs of the system; that is, the threshold occupancy value should be set sufficiently below the maximum capacity of the IQ to accommodate the longest possible data segment (or a data segment of a fairly long length), to thereby avoid overfilling an IQ when a long data segment is sent to a selected IQ.

If step 1034 finds that another IQ needs to be found to receive the word, step 1036 will check whether any of the IQs have an occupancy value below the threshold maximum occupancy value. If there is an IQ with an appropriate occupancy, then at step 1040, one of those IQs is selected. If all IQs have occupancy values exceeding the threshold, then at step 1046, the input scheduler terminates the input scheduling frame. By terminating the input scheduling frame when all IQs are filled to the threshold, the invention allows the output scheduler to take over. While the input scheduler waits for a subsequent input scheduling frame, the processing elements will have dequeued many of the words buffered in the IQs, thereby freeing up space in the IQs. Thus, during a subsequent input scheduling frame, there will be space in the IQs to write words.

From steps 1032, 1038 and 1040, the input scheduler proceeds to step 1042, where it writes the word to the selected IQ over the data bus. This constitutes the input transaction. The input scheduler writes the word in the selected IQ at the internal write pointer for that IQ maintained by the queue manager. After the word has been written, the input scheduler proceeds to step 1044 where it updates its internal write pointer value for the selected IQ to identify the next address in that IQ which will receive a word. From step 1044, the input scheduler will loop back to step 1024 and restart the process.

Should the input scheduling frame terminate during any of these steps, the input scheduler will cease operations and maintain its state at the time of frame termination so that when it restarts during a subsequent input scheduling frame, it can pick up where it eft off. Also, because the data scheduler will stop the input scheduler when the input scheduling frame terminates, the input scheduler does not need to track the number of input transactions performed and compare them with the target number of transactions for the frame, thereby reducing the complexity of the input scheduler.

This methodology of writing a word to an IQ only if the IQ has an occupancy below a threshold value, helps provide a fairly even distribution of words among the parallel processing elements, which enhances throughput for the system. For example, if IQ(A) has a long wait before words queued therein will reach a processing element, and IQ(B) has a much shorter wait before words queued therein will reach a processing element, it would be advantageous to write a word to IQ(B) to avoid unnecessarily delaying processing of that word. Thus, the present invention takes the occupancies of the IQs into account when selecting the IQ into which to write the words and seeks to write the word into an IQ where the delay will not be unnecessarily long.

B.4: Output Scheduler

The output scheduler 180 performs the reading of words from the OQs over the bi-directional data bus during the output scheduling frame. The duration of the output scheduling frame will be set by the data scheduler as explained above such that the output scheduler has sufficient time to complete the target number of output transactions determined for the output scheduling frame.

FIG. 9(d) is a timing diagram depicting how the output transactions can be allocated during the output scheduling frames. The output scheduler is configured to select an OQ, preferably doing so in a round-robin fashion. Once an OQ has been selected, the output scheduler will determine a target number of output transactions for that OQ as a function of the occupancy of that OQ. If there are output transactions left in the output scheduling frame after allotting output transactions to the first-selected OQ, then the output scheduler will select another OQ and determine a target number of transactions for that OQ. This process will continue for the duration of the output scheduling frame. In FIG. 9(d), it can be seen that the output scheduling frame 198 includes 11 output transactions 224. The first two output transactions were given to OQ(A). The next three output transactions were given to OQ(B), the next output transaction was given to OQ(C), and the final 5 output transactions were given to OQ(D). Wait cycles 226 were inserted on the data bus between each OQ transition to eliminate the likelihood of bus contention when changing from reading words from one OQ to the next.

The output scheduler allocated output transactions to each selected OQ(A-D) on the basis of each selected OQ's own occupancy. The occupancies of the other OQs will not affect this determination. This feature of the output scheduler allows the present invention to be scaled to include a large number of OQs, because the addition of OQs will not cause an increase in computation complexity during the output scheduling frame. If the output scheduler took the occupancies of all of the OQs into consideration when determining how many output transactions to assign to an OQ, the computational complexity required to arrive at such a value will increase as more OQs are added to the system, thereby hindering the flexibility of the invention to be scaled to include a larger number of OQs. Increasing the number of IQs and OQs may be desirable if one wants to increase the capacity of the system.

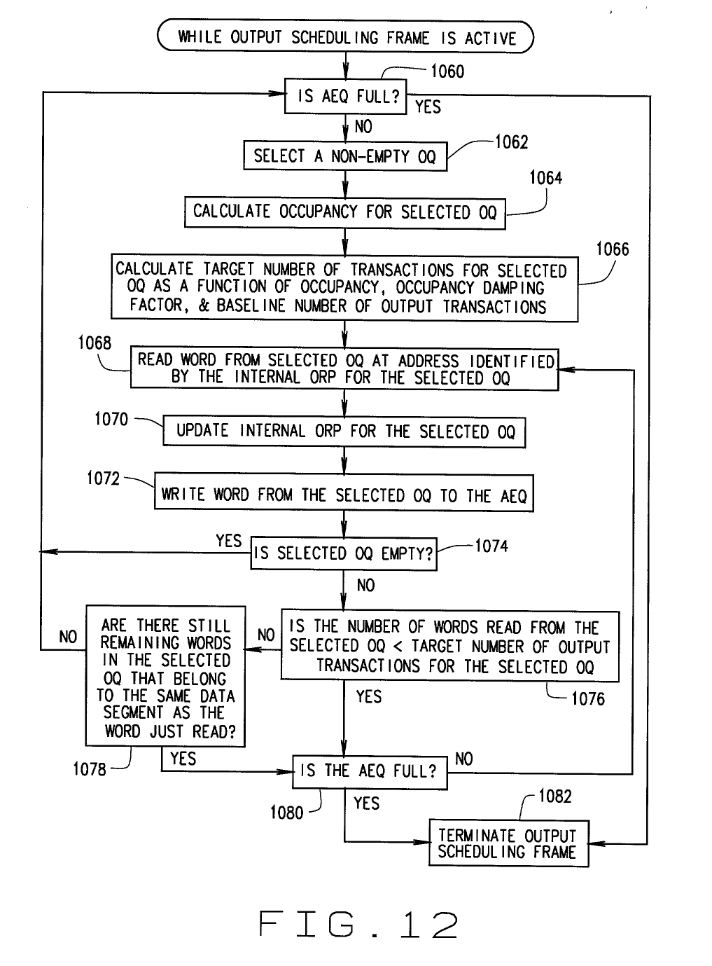

FIG. 12 depicts a flowchart for the operation of the output scheduler. At step 1060, the output scheduler determines whether the AEQ is full by checking whether the AEQ occupancy equals the AEQ capacity. Alternatively, step 1060 can determine whether the AEQ is filled beyond a threshold occupancy (rather than whether it is “full”). If the AEQ is full, then the output scheduler proceeds to step 1082 and prematurely terminates the output scheduling frame. When the AEQ is full, no output transactions are needed because they have no place to go. By terminating the output scheduling frame, time on the data bus can be devoted to other tasks. When words have been dequeued from the AEQ and space is freed up therein, then on a subsequent output scheduling frame, output transactions can proceed over the data bus.

If the AEQ is not full, then the output scheduler proceeds to step 1062 where it selects a non-empty OQ. Preferably, the OQs are selected in a round-robin fashion so on subsequent step 1062s, different OQs can be served. However, the invention need not be limited to selecting an OQ in a round-robin fashion. Next, at step 1064, the occupancy of the selected OQ is calculated according to formula 1 described above.

From this calculated occupancy, the output scheduler can determine a target number of output transactions for the selected OQ during the output scheduling frame. By factoring the OQ occupancy into the calculation, the present invention can tailor an OQ's access to the data bus to reflect how much data stored in that OQ that needs to travel on the bus.

At step 1066, the output scheduler calculates a target number of output transactions for the selected OQ according to the formula:

OT Target_{OQ(i)}=(OQ(i) occupancy/ODF)+Baseline # OTs (4)

In this equation, OT Target_{OQ(i)} represents the target number of output transactions for the selected OQ(i), OQ(i) occupancy represents the occupancy for the selected OQ (calculated using formula 1), ODF represents an occupancy damping factor, and Baseline # OTs represents a default value for the number of output transactions that will be assigned to a selected OQ during a given output scheduling frame.

Both the occupancy damping factor (ODF) and the baseline number of output transactions can be set by a practitioner of the present invention to achieve certain objectives. By setting the ODF to a high value, the influence that the OQ occupancy has on the resultant number of output transactions assigned to the selected OQ decreases, thereby resulting in an allocation of output transactions among the OQs in the output scheduling frame that is somewhat rigidly equal. Essentially, each OQ will get a number of output transactions equal to the baseline number, regardless of how full each OQ is. Setting the ODF to a high value may be desirable when one does not want the relative workload of a PE to affect the other PEs.

By setting the baseline value to a small number, the result will be an allocation of output transactions to the selected OQs that highly reflects the occupancies of the OQs. This result may be desirable in that it will allow the relative demand for the data bus to strongly factor into how bus access is allocated. However, in situations when many of the OQs are not very full, a result may arise where several OQs are assigned slots in the output scheduling frame because each OQ will receive only a few output transactions. Because wait cycles will be inserted between the OQ transitions, bandwidth on the bus will be wasted as more bus time will be devoted to wait cycles because of the numerous OQ transitions. This same result will happen when the baseline value is set low and the ODF is set to a value approaching 1. The target number of output transactions for the selected OQ will highly reflect that OQ's occupancy. Low latency is achieved, but some bandwidth tradeoff will exist

If the baseline value is set too high, then an OQ may be served when it would be more advantageous to serve another OQ with a higher occupancy.

To allow for easy implementation in a logic circuit, the ODF value is preferably set to be a power of 2, thereby allowing the division to be performed with a barrel shifter. The preferred range of values for the ODF is 0-15, with preferred ODF value being 4. The preferable range of values for the baseline number of transactions assigned to the selected QC is 0-255, with the preferred value being 16.

After the target number of output transactions for the selected OQ is found, the output scheduler proceeds to step 1068 where the output scheduler reads a word from the selected OQ over the data bus at the address identified by the internal read pointer for that OQ. This is an output transaction. Then, at step 1070, the output scheduler updates the internal read pointer for the selected OQ with the address where the next word to be dequeued from that OQ is stored. At step 1072, the output scheduler writes the word read from the selected OQ to the AEQ.

Thereafter, at step 1074, the output scheduler checks whether the selected OQ has become empty. If it has become empty, then the output scheduler loops back to step 1060 and checks whether the AEQ is full. If the selected OQ still has a word stored therein, the output scheduler proceeds to step 1076 and checks whether the selected OQ has used its allotted target number of output transactions. If the OQ has no remaining output transactions left to it, the output scheduler proceeds to step 1078. At step 1078, the output scheduler determines whether there are still words remaining in the selected OQ that belong to the same data segment as the word just read from the selected OQ. If words belonging to that data segment are left in the selected OQ, then the output scheduler loops back to step 1080, where it checks whether the AEQ is full. If the next word in the selected OQ does not belong to that data segment, then the output scheduler loops back to step 1060. Step 1078 is needed to avoid data segment fragmentation in situations where data segment boundaries do not coincide with the target number of transactions boundaries

If the AEQ found to be full at step 1080, then the output scheduler proceeds to step 1082 and prematurely terminates the output scheduling frame. If step 1080 determines that the AEQ is not full, then the output scheduler loops back to step 1068 and reads another word from the selected OQ over the data bus.

Like the input scheduler, if the output scheduling frame ends while the output scheduler is at any of the steps in the flowchart, then the output scheduler stores its values for the selected OQ, and will resume operations for the selected OQ during a subsequent output scheduling frame. Thus, when an output scheduling frame begins, the output scheduler may start at any of the steps listed in FIG. 12, depending upon where the output scheduler left off when the last output scheduling frame terminated.

B.5: Pointer Scheduler

The pointer scheduler 176 performs pointer transactions during the pointer scheduling frame. An input pointer transaction occurs when the pointer scheduler updates the pointers stored in the DPRAMs by writing new IWP and ORP values to the DPRAMs over the data bus during the pointer scheduling frame. An output pointer transaction occurs when the pointer scheduler updates the queue manager's internal pointer values for the IRP and OWP of the IQs and OQs by reading those values from the DPRAMs over the data bus during the pointer scheduling frame.

The duration of the pointer scheduling frame will be set by the main scheduler as explained above. Preferably, there will be a sufficient amount of time in the pointer scheduling frame to read two ingress pointer words (two output pointer transactions) from a DPRAM and write two egress pointer words (two input pointer transactions) to a DPRAM. An ingress pointer word comprises the OWP and IRP values that need to be read by the queue manager. Each DPRAM will store an ingress pointer word therein for each IQ/OQ pair included in the DPRAM. An egress pointer word comprises the IWP and ORP values that need to be written to a DPRAM by the queue manager. Each DPRAM will store an egress pointer word therein for each IQ/OQ pair included in the DPRAM.

FIG. 9(e) is a timing diagram depicting how the pointer transactions can be allocated during the pointer scheduling frame. As explained above, the queue manager will be configured to read/write pointers from/to the IQs and OQs in the opposite direction that the processing elements perform those operations, to thereby facilitate detection of pointer corruption due to simultaneous access of a pointer address in a DPRAM by the queue manager and a processing element. Because most processing elements will be configured to perform reading and writing in a forward direction, it is preferable that the queue manager be configured to perform reading and writing of pointers in backwards direction. However, it must be noted that the scope of the present invention encompasses queue manager's that read/write pointers in a forward direction if the processing elements read/write pointers in a backward direction.

FIG. 9(e) shows a first pointer transaction 226 comprising reading copy 2 of the ingress pointer word for an IQ/OQ pair in a DPRAM. The next pointer transaction 228 comprises reading copy 1 of the ingress pointer word for that IQ/OQ pair in the DPRAM. After wait cycles 230 have been inserted on the data bus to eliminate the possibility of bus contention when switching from an output pointer transaction to an input pointer transaction, the pointer scheduler writes copy 2 of the egress pointer word for an IQ/OQ pair to a DPRAM (pointer transaction 232). Next, with pointer transaction 234, the pointer scheduler writes copy 1 of the egress pointer word to that IQ/OQ pair to the DPRAM. It should be noted that the pointer scheduler can be configured to perform input pointer transactions prior to output pointer transactions, and can even be configured to interleave input and output pointer transactions.

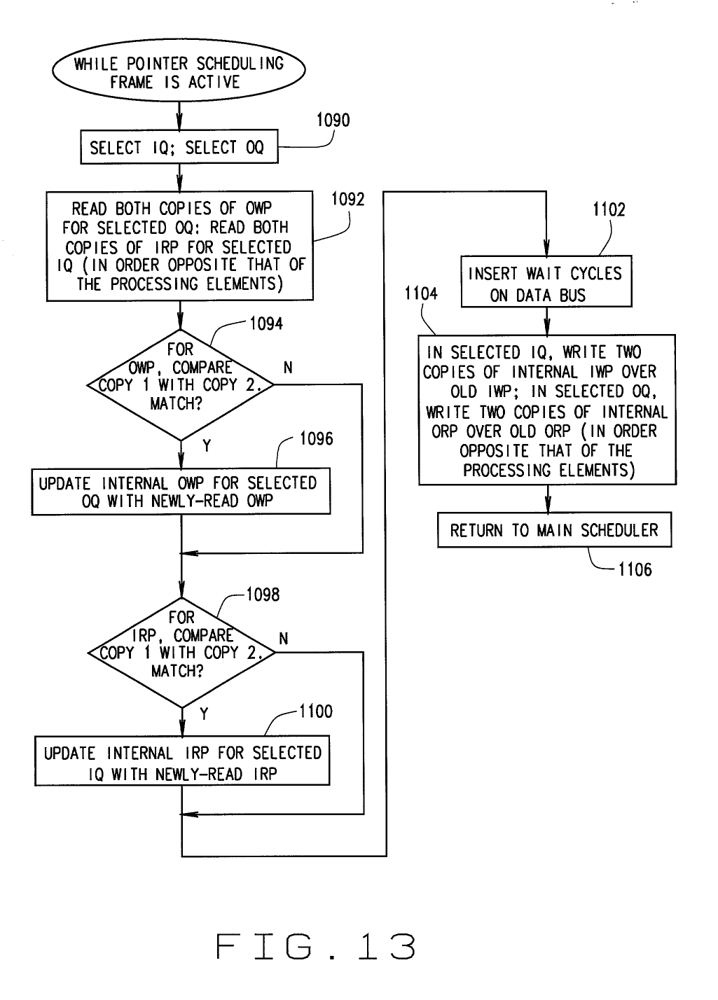

FIG. 13 depicts a flowchart for the operation of the pointer scheduler. After selecting an IQ and an OQ (step 1090), the pointer scheduler reads both copies of the IRP of an IQ and both copies of the OWP of an OQ (step 1092). Preferably these values are stored in the same word in a DPRAM containing the selected IQ and selected OQ, to thereby minimize the number of bus transactions that are needed to read the pointers. The steps of two read transactions and two write transactions is repeated each pointer scheduling frame 194.

If the two copies of the OWP do not match, then the pointer scheduler does not update the queue manager's internal OWP value for that OQ. If the copies do match, the internal OWP value for that OQ is updated with the newly-read value (steps 1094 and 1096). If the two copies of the IRP do not match, then the pointer scheduler does not update the queue manager's internal IRP value for that IQ. If the copies do match, the internal IRP value for that IQ is updated with the newly-read value (steps 1098 and 1100).

Next, the pointer scheduler inserts a sufficient number of wait cycles on the bi-directional data bus to eliminate the possibility of bus contention when changing from reading operations to writing operations (step 1102). Lastly, the pointer scheduler writes both copies of the queue manager's internal IWP for an IQ and internal ORP for an OQ to that IQ and that OQ (step 1104). Preferably the IWP and ORP values are put in the same word so only two pointer transactions are needed to write the new IWP and ORP values to the DPRAM. Control of the bi-directional data bus is then returned back to the main scheduler for a new cycle (step 1106). Preferably, each pointer scheduling frame, a different IQ and a different OQ is selected for pointer updating at step 1090 in a round-robin fashion.

As explained above, because the queue manager is configured to read and write in the opposite direction of the processing elements, the present invention avoids a situation where pointer corruption can go undetected. Whenever a pointer is corrupted, steps 1094 and 1098 will detect the corruption and prevent the pointer scheduler from updating the queue manager's internal pointers with misread values.

C. Processing Elements

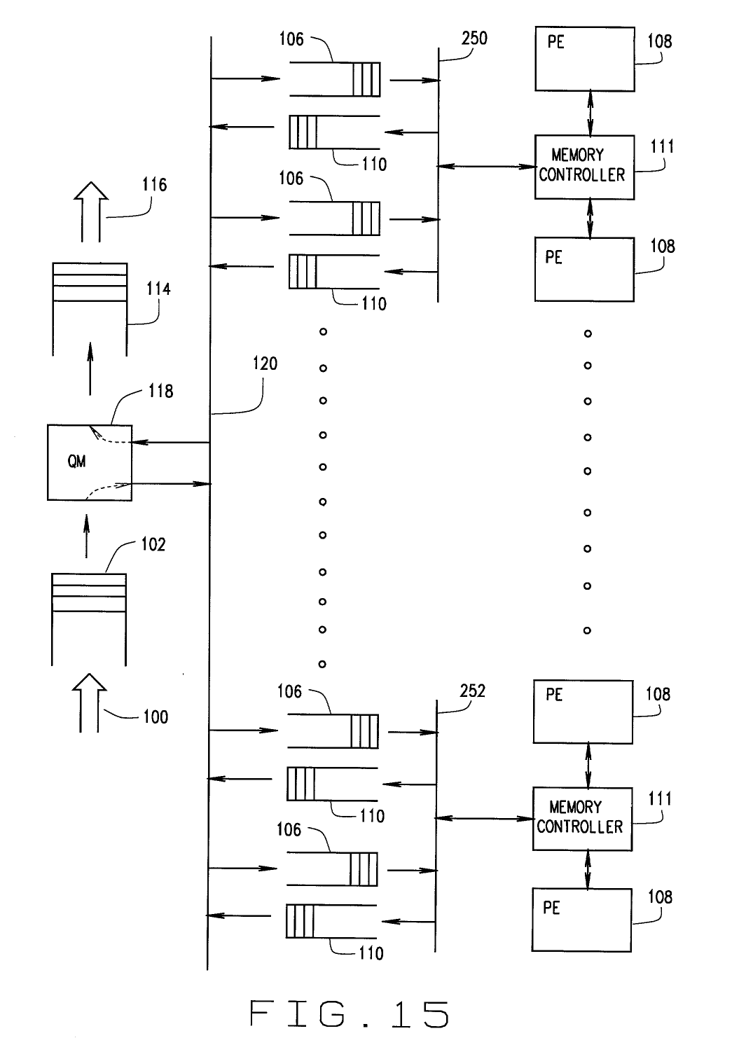

It should be pointed out that the processing elements that may be used in the present invention can receive data from the IQs and send processed data back to the OQs via additional bi-directional data buses 250 and 252, as shown in FIG. 15. Each processing element may be linked to its IQ and QQ via a different bi-directional data bus, the same bi-directional data bus, or some combination therebetween. For example, FIG. 15 depicts two processing elements 108 per bi-directional data bus. A memory controller handles bus arbitration between the two PEs to which each is connected.

Each processing element can be configured with a device that performs the scheduling method of the present invention by dynamically controlling access to the additional bi-directional data bus to which it is linked between the two directions of traffic (words entering the processing elements from the IQs and words leaving the processing elements for the OQs).

If each processing element is served by only one IQ and only one OQ, then the input scheduler implemented on the processing element need not have to select an IQ from among a plurality of IQs (steps 1028 through 1038 in FIG. 11), and the output scheduler implemented on the processing element need not have to select an OQ to serve during the output scheduling frames (step 1062 in FIG. 12). However, if each processing element is served by a plurality of IQs and a plurality of OQs, the input and output schedulers will need to be able to arbitrate among the plurality of IQs and OQs as explained above in connection with the queue manager.

D. Initialization

In the present invention, the queue manager initially treats all processing element “channels” as “closed”. A processing element channel is the IQ and OQ supporting a processing element. When a channel is closed, no input data is sent to any of the processing elements (words going from the queue manager to the closed IQ or words going from the closed IQ to the PE), no output data is received from any of the processing elements (words going from the closed OQ to the queue manager or words going from the OE to the closed OQ), and no pointers are read nor written for any of the processing elements. To initialize the queue manager, these channels must first be brought up. A channel is brought up by 1) the processing element writing both the input pointers and the output pointers for the channel; 2) the queue manager being signaled by some means to read these pointers; and 3) when complete, the queue manager signals by some means that it has read all the pointers and the channel is now “open”. To bring down a channel, a processing element can signal to the queue manager by some means to bring down the channel, and then the channel will be in the same state as it is at initialization, i.e. closed.

E. Error Conditions

When the queue manager is reading the input data from the AIQ, there are many ways that the data can be malformed. Because the data segments of the present invention in the AIQ are explicitly delineated, the queue manager can just search for the beginning of the next data segment if there are any data corruptions.

When the queue manager is reading the output data from any of the OQs, there are many ways that the data can be malformed. In the present invention, each data segment has contained therein a constant 8-bit marker in the same location of the first word. If the value of the marker is not what is expected, the queue manager can be configured to immediately close the channel and signal an exception.

F. “Halted” Processing Elements

When a processing element is reading input data, it should occasionally update its IRP. For each channel, the queue manager keeps a constantly decrementing counter. Each time the queue manager reads an IRP and the occupancy of the corresponding IQ is non-empty and the IRP is different from its previous value, then the corresponding decrementing counter is set back to a programmable initial value. If the processing element is not reading input data that it can read, then the decrementing counter will become zero. If the decrementing counter reaches zero, then the channel is marked as “halted”. If the channel is halted, then no more input data segments are sent to the channel (no input transactions are written by the queue manager to the IQ of that channel), the input data segments are redirected to a different processing element. The channel becomes normal (i.e., open) only after the occupancy of its IQ becomes empty (the processing element of the channel will still be reading words from that IQ). Output data segments are still read from halted channels (the queue manager will still read output transactions from the OQ of that channel).

G. Performance

The present invention is capable of performing well in a number of extenuating situations. The data scheduler is configured to efficiently and dynamically allocate time on the bi-directional data bus according to whether input transactions or output transactions are needed. The input scheduler is configured to distribute words among the IQs such that a given IQ is not overloaded with words while another IQ is relatively empty, thereby improving throughput. The output scheduler is configured to achieve a balance between which OQs have access to the bi-directional data bus and how much bandwidth is wasted during the output scheduling window. Lastly, the pointer scheduler is configured to periodically update the pointer values in the queues and do so in a manner where pointer corruption can be detected.

Under light aggregate data flow loads (<10% of the maximum load), the input scheduler and output scheduler usually give up control of the bi-directional data bus early. This causes the pointer updates to happen more frequently and bus turnarounds to happen more frequently, which causes lower data latency through the system.

Under heavy aggregate data flow loads (>90% of the maximum load), the input scheduler and output scheduler usually take their fully allocated transactions to move data across the bi-directional data bus. This causes the pointer updates to happen less frequently and bus turnarounds to happen less frequently, which increases the throughput utilization of the bi-directional data bus.

It is easily understood that one having ordinary skill in the art would recognize many modifications and variations within the spirit of the invention that may be made to the particular embodiments described herein. Therefore, the scope of the present invention is not intended to be limited solely to the particular embodiments described herein, which are intended to be illustrative. Instead, the scope of the present invention should be determined by reference to the claims below in view of the specification and figures, together with the full scope of equivalents allowed under applicable law.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. In a network processor for switching data between an input and an output, a method for dynamically controlling data traffic over a bidirectional data bus, said method comprising the step of allocating bus access between input direction traffic and output direction traffic based upon a relative demand for bus access between each of said traffic types.

2. The method of claim 1 wherein said network processor further comprises an aggregate ingress queue for buffering said input direction traffic and an aggregate egress queue for buffering said output direction traffic, and wherein the method further comprises determining said relative demand by determining an occupancy value for each of said aggregate queues and determining an input/output bias factor from said occupancy values, said input/output bias factor being representative of said relative demand.

3. The method of claim 2 wherein said allocating step further comprises dividing said bus access into a plurality of windows, each of said windows having an input scheduling frame and an output scheduling frame, wherein said input direction traffic is permitted access to said bus during said input scheduling frame, and wherein said output direction traffic is permitted access to said bus during said output scheduling frame.

4. The method of claim 3 wherein said allocating step further comprises the step of determining a duration for each of said input scheduling frames and said output scheduling frames in each of said windows.

5. The method of claim 4 wherein said step of determining said relative demand further comprises determining said relative demand in response to a bias damping factor, said bias damping factor at least partially defining a proportional relationship between said input/output bias factor, said input scheduling frame duration, and said output scheduling frame duration.

6. The method of claim 5 further comprising the step of selecting said bias damping factor.

7. The method of claim 5 wherein said step of determining either one of said input scheduling frame duration or said output scheduling frame duration comprises determining said duration in response to a target number of transactions therefor.

8. The method of claim 7 wherein said data traffic comprises a plurality of words, wherein said network processor further comprises a plurality of input queues for buffering words of said input direction traffic received from said aggregate ingress queue, and wherein said method further comprises the steps of reading a word buffered in said aggregate ingress queue, determining a relative occupancy for said input queues to identify an appropriate input queue for receiving said word, and writing said word into said appropriate input queue over said bus during said input scheduling frame.

9. The method of claim 8 further comprising the step of terminating the input scheduling frame prior to the end of its duration should the aggregate ingress queue become empty.

10. The method of claim 9 wherein the step of determining the relative occupancy comprises determining an occupancy for an input queue and comparing said occupancy with a threshold occupancy value.

11. The method of claim 8 further comprising the steps of determining from said word read from said aggregate ingress queue a desired destination input queue therefor and selecting said desired destination input queue as said appropriate input queue depending upon said comparison between said occupancy value for said desired destination input queue and said threshold occupancy value.

12. The method of claim 11 further comprising redirecting said word to another input queue if said desired destination input queue has an occupancy value exceeding said threshold occupancy value.

13. The method of claim 10 wherein the network processor further comprises a plurality of output queues for buffering words of said output direction traffic, and the method further comprises the steps of selecting an output queue, determining the occupancy for said selected output queue, assigning a number of transactions to said output queue at least in part according to said determined occupancy, reading a number of words from said output queue during said output scheduling frame up to said assigned number of transactions but no longer than said output scheduling frame duration, and repeating the foregoing steps until the end of said output scheduling frame duration.

14. The method of claim 12 further comprising the step of terminating the output scheduling frame prior to the end of its duration should the aggregate egress queue become full.

15. The method of claim 2 wherein each of said windows further has a pointer scheduling frame during which pointer traffic is permitted to access said bus.

16. The method of claim 15 further comprising the steps of recording at least two values corresponding to each pointer during each of said pointer scheduling frames, reading the recorded values corresponding to any one pointer during each of said pointer scheduling frames, and comparing the read values of said any one pointer for a match prior to using said any one pointer for writing or reading traffic.

17. A network processor for switching data between an input and an output, said network processor comprising a bi-directional data bus over which data traffic flows in an input direction and an output direction, said bus linking an aggregate ingress queue with a data processor in said input direction and linking said data processor with an aggregate egress queue in said output direction, and a queue manager connected in circuit with said aggregate queues and said bus, said queue manager being configured to dynamically allocate bus access between traffic in each direction based upon a relative demand for bus access between each of said traffic directions.

18. The network processor of claim 17 wherein said queue manager is further configured to (1) determine an input/output bias factor for said bus, (2) determine said relative demand for bus access as a function of said input/output bias factor, and (3) dynamically allocate bus access by dividing each of a plurality of windows of time on said bus into an input scheduling frame and an output scheduling frame, wherein said input direction traffic is permitted to access said bus during said input scheduling frame, wherein said output direction traffic is permitted to access said bus during said output scheduling frame, and wherein each input scheduling frame and each output scheduling frame has a duration that is dynamically allocated according to said determined relative demand.

19. The network processor of claim 18 wherein said queue manager is further configured to determine said relative demand as a function of a bias damping factor.

20. The network processor of claim 18 wherein said queue manager is further configured to (1) determine a target number of transactions for said input scheduling frame and said output scheduling frame, (2) assign a duration to said input scheduling frame sufficient to accommodate said determined target number of transactions therefor, and (3) assign a duration to said output scheduling frame sufficient to accommodate said determined number of transactions therefor.

21. The network processor of claim 18 wherein said queue manager is further configured to (1) determine an occupancy value for said aggregate ingress queue, (2) determine an occupancy value for said aggregate egress queue, and (3) determine said input/output bias factor as a function of said determined occupancy values for said aggregate ingress queue and said aggregate egress queue.

22. The network processor of claim 18 further comprising a plurality of input queues for buffering said input direction traffic and a plurality of output queues for buffering said output direction traffic, wherein said input queues and said output queues interface said data processor with said bus, and wherein said data processor comprises a plurality of parallel processing elements, each parallel processing element being associated with at least one of said input queues and at least one of said output queues and being configured to (1) receive input direction traffic from said at least one associated input queue, (2) process said received input direction traffic, and (3) provide said processed traffic to said at least one associated output queue, wherein said processed traffic comprises said output direction traffic.

23. The network processor of claim 22 wherein said queue manager is further configured to (1) determine an occupancy value for each input queue, (2) during said input scheduling frame, select one of said input queues and write a word stored in said aggregate ingress queue to said selected input queue over said bi-directional data bus if said determined occupancy value for said selected input queue is less than a predetermined threshold occupancy value.

24. The network processor of claim 22 wherein said queue manager is further configured to, during said output scheduling frame, (1) select one of said output queues, (2) determine an occupancy value for said selected output queue, (3) determine a target number of output transactions for said selected output queue as a function of said determined occupancy value for said selected output queue, and (4) read a number of words from said selected output queue over said bi-directional data bus, wherein said determined number of output transactions for said selected output queue represents a maximum number of words read from said selected output queue during said output scheduling frame, and wherein the foregoing steps are repeated if said output scheduling frame is still active when said queue manager is finished reading words from said selected output queue.

25. The network processor of claim 24 wherein said plurality of input queues and said plurality of output queues are implemented on a plurality of dual port RAMs (DPRAMs), each DPRAM comprising at least one of said input queues and at least one of said output queues.

26. The network processor of claim 25 wherein said plurality of input queues and output queues are implemented on a plurality of DPRAMs, each DPRAM comprising two input queues and two output queues.

27. The network processor of claim 24 wherein said queue manager and said data processor are in mutually asynchronous clock domains.

28. The network processor of claim 22 wherein said queue manager is further configured to include a pointer scheduling frame in each of said windows, wherein pointer traffic is permitted to access said bus during each pointer scheduling frame.

29. The network processor of claim 24 wherein each DPRAM further comprises a plurality of stored pointer values for each input queue and each output queue implemented on said DPRAM, said stored pointer values comprising two copies of an input write pointer for each input queue implemented on said DPRAM, two copies of an input read pointer for each input queue implemented on said DPRAM, two copies of an output write pointer for each output queue implemented on said DPRAM, two copies of an output read pointer for each output queue implemented on said DPRAM, wherein said queue manager is further configured to (1) read both copies of an input read pointer and both copies of an output write pointer stored in a DPRAM during each pointer scheduling frame, (2) write both copies of an input write pointer and both copies of an output read pointer stored in a DPRAM during each pointer scheduling frame, wherein said data processor is configured to (1) write both copies of an input read pointer and both copies of an output write pointer stored in a DPRAM, (2) read both copies of an input write pointer and both copies of an output read pointer stored in a DPRAM, and wherein said queue manager is further configured to read and write said pointer copies in a different order than said data processor is configured to do so.

30. The network processor of claim 29 wherein said queue manager is further configured to (1) compare both copies of a read input read pointer to determine whether a match exists, and (2) update an internal input read pointer value with said read input read pointer only if said comparison results in a match, (3) compare both copies of a read output write pointer to determine whether a match exists, and (2) update an internal output write pointer value with said read output write pointer only if said comparison results in a match.

31. The network processor of claim 24 further comprising a plurality of additional bi-directional data buses over which said input direction traffic and said output direction traffic flows, each additional bi-directional data bus linking one of said parallel processing elements with its at least one associated input queue in an input direction and with its at least one associated output queue in an output direction, and wherein each parallel processing element is configured to dynamically allocate access to said additional bus to which it is linked between traffic in each direction based upon a relative demand for access to said additional bus between each of said traffic directions.

32. A device for dynamically controlling data traffic over a bi-directional data bus, said device comprising a data scheduler configured to allocate bus access between input direction traffic and output direction traffic based upon a relative demand for bus access between each of said traffic types.

33. The device of claim 32 wherein said device is linked to an aggregate ingress queue from which it dequeues input direction traffic and linked to an aggregate egress queue to which it queues output direction traffic, and wherein said data scheduler is further configured to determine said relative demand by determining an occupancy value for each of said aggregate queues and determining an input/output bias factor from said occupancy values, said input/output bias factor being representative of said relative demand.

34. The device of claim 33 further comprising a main scheduler configured to divide said bus access into a plurality of windows, each of said windows having a data scheduling frame, and wherein said data scheduler is further configured to divide each of said data scheduling frames into an input scheduling frame and an output scheduling frame, wherein said input direction traffic is permitted access to said bus during said input scheduling frame, and wherein said output direction traffic is permitted access to said bus during said output scheduling frame.

35. The device of claim 34 wherein said data scheduler is further configured to allocate said bus access by determining a duration for each of said input scheduling frames and said output scheduling frames in each of said windows.

36. The device of claim 35 wherein said data scheduler is further configured to determine said relative in response to a bias damping factor, said bias damping factor at least partially defining a proportional relationship between said input/output bias factor, said input scheduling frame duration, and said output scheduling frame duration.

37. The device of claim 36 wherein said bias damping factor is predetermined.

38. The device of claim 36 wherein said data scheduler is further configured to (1) determine a target number of transactions for either one of said input scheduling frame or said output scheduling frame, and (2) determine either one of said input scheduling frame duration or said output scheduling frame duration in response to said determined target number of transactions.

39. The device of claim 38 wherein said data traffic comprises a plurality of words, wherein said device is further linked via said bus to a plurality of input queues for buffering words of said input direction traffic received from said aggregate ingress queue, and wherein said device further comprises an input scheduler configured to (1) read a word buffered in said aggregate ingress queue, (2) determine a relative occupancy for said input queues to identify an appropriate input queue for receiving said word, and (3) write said word into said appropriate input queue over said bus during said input scheduling frame.

40. The device of claim 39 wherein said input scheduler is further configured to terminate an input scheduling frame prior to the end of its duration should the aggregate ingress queue become empty.

41. The device of claim 40 wherein said input scheduler is further configured to determine the relative occupancy for an input queue by determining an occupancy for that input queue and comparing said occupancy with a threshold occupancy value.

42. The device of claim 41 wherein said input scheduler is further configured to determine from said word read from said aggregate ingress queue a desired destination input queue therefor, and select said desired destination input queue as said appropriate input queue depending upon said comparison between said occupancy value for said desired destination input queue and said threshold occupancy value.

43. The device of claim 41 wherein said device is further linked via said bus to a plurality of output queues for buffering words of said output direction traffic, and wherein said device further comprises an output scheduler configured to (1) select an output queue, (2) determine the occupancy for said selected output queue, (3) assign a number of transactions to said output queue at least in part according to said determined occupancy, (4) read a number of words from said output queue during said output scheduling frame up to said assigned number of transactions but no longer than said output scheduling frame duration, and (5) repeat the foregoing steps until the end of said output scheduling frame duration.

44. The device of claim 43 wherein said output scheduler is further configured to terminate the output scheduling frame prior to the end of its duration should the aggregate egress queue become full.

45. The device of claim 44 wherein each of said windows further includes a pointer scheduling frame during which pointer traffic is permitted to access said bus.

46. The device of claim 45 further comprising a pointer scheduler configured to (1) record during each pointer scheduling frame at least two values corresponding to a pointer, (2) read during each pointer scheduling frame the recorded values corresponding to any one pointer, and (3) compare the read values of said any one pointer for match prior to using said any one pointer for writing or reading traffic.

47. A method of dynamically controlling data flow on a bi-directional data bus, wherein said data flow comprises input direction traffic traveling over said bi-directional data bus from an aggregate ingress queue (AIQ) to a plurality of input queues (IQs) and output direction traffic traveling over said bi-directional data bus from a plurality of output queues (OQs) to an aggregate egress queue (AEQ), wherein said input direction traffic and said output direction traffic are both comprised of a plurality of words, and wherein each of said queues has a plurality of addresses therein for storing words, said method comprising:
a) dividing a window into a data scheduling frame having a size sufficient for a number of word transactions and a pointer scheduling frame;
b) determining an input/output bias factor for said bi-directional data bus;
c) dividing said data scheduling frame into an input scheduling frame and an output scheduling frame such that said input scheduling frame and said output scheduling frame have sizes relative to each other that depend at least in part upon said determined input/output bias factor;
d) during said input scheduling frame, writing a number of words stored in said AIQ to at least one of said IQs over said bi-directional data bus;
e) during said output scheduling frame, reading a number of words stored in at least one of said OQs and destined for said AEQ over said bi-directional data bus; and
f) during said pointer scheduling frame, updating at least one pointer for at least one of said IQs or at least one of said OQs, wherein each pointer identifies a queue address to which a next word will be written or from which a next word will be read.

48. The method of claim 47 wherein said input/output bias factor determining step includes:
determining a value representing an occupancy of said AIQ;
determining a value representing an occupancy of said AEQ; and
calculating said input/output bias factor as a function of said determined AIQ occupancy value and said determined AEQ occupancy value.

49. The method of claim 48 wherein said data scheduling frame dividing step includes:
calculating a number of input transactions for said input scheduling frame as a function of said input/output bias factor and said number of word transactions;
assigning a duration to said input scheduling frame sufficient to accommodate said determined number of input transactions; and
assigning a duration to said output scheduling frame equal to a remainder of said data scheduling frame.

50. The method of claim 49 wherein said step of calculating said number of input transactions for said input scheduling frame includes calculating said number of input transactions as a function of a predetermined bias damping coefficient.

51. The method of claim 50 wherein said input/output bias factor determining step further includes:
determining a word capacity for said AIQ;
determining a word capacity for said AEQ; and
wherein said input/output bias factor calculation step includes calculating said input/output bias factor according to the formula: input/output bias factor=(said determined occupancy of said AIQ+said determined occupancy of said AEQ)−((said determined word capacity of said AIQ+said determined word capacity of said AEQ)/2).

52. The method of claim 51 wherein said step of calculating said number of input transactions for said input scheduling frame further includes calculating said number of input transactions for said input scheduling frame according to the formula: said number of input transactions for said input scheduling frame=(said number of word transactions for said data scheduling frame/2)+(said determined input/output bias factor*said predetermined bias damping factor)

53. A method of dynamically controlling data flow on a bi-directional data bus, wherein said data flow comprises input direction traffic traveling over said bi-directional data bus from an aggregate ingress queue (AIQ) to a plurality of input queues (IQs) and output direction traffic traveling over said bi-directional data bus from a plurality of output queues (OQs) to an aggregate egress queue (AEQ), wherein said input direction traffic and said output direction traffic are both comprised of a plurality of words, and wherein each of said queues has a plurality of addresses therein for storing words, said method comprising:
a) dividing a window into a data scheduling frame having a size sufficient for a number of word transactions and a pointer scheduling frame;
b) dividing said data scheduling frame into an input scheduling frame and an output scheduling frame;
c) for each IQ, determining a value representing an occupancy thereof;
d) during said input scheduling frame, writing a number of words stored in said AIQ to at least one of said IQs over said bi-directional data bus by, for each of said number of words, (1) selecting an IQ in which to write said word stored in said AIQ according to said determined occupancy value for that IQ relative to a predetermined threshold value, and (2) writing said word stored in said AIQ to an address in said selected IQ over said bi-directional data bus;
e) during said output scheduling frame, reading a number of words stored in at least one of said OQs and destined for said AEQ over said bi-directional data bus; and
f) during said pointer scheduling frame, updating at least one pointer for at least one of said IQs or at least one of said OQs, wherein each pointer identifies a queue address to which a next word will be written or from which a next word will be read.

54. The method of claim 53 wherein said IQ selecting step includes:
determining a desired destination IQ for said word stored in said AIQ;
if said determined occupancy value for said determined IQ is less than a predetermined threshold occupancy value, selecting said determined IQ;
if said determined occupancy value for said determined IQ is greater than or equal to said predetermined threshold occupancy value and if at least one other of said IQs has a determined occupancy less than said predetermined threshold occupancy value, selecting one of said IQs having a determined occupancy less than said predetermined threshold occupancy value; and
if all of said IQs have a determined occupancy value greater than or equal to said predetermined threshold occupancy value, terminating said input scheduling frame.

55. A method of dynamically controlling data flow on a bi-directional data bus, wherein said data flow comprises input direction traffic traveling over said bi-directional data bus from an aggregate ingress queue (AIQ) to a plurality of input queues (IQs) and output direction traffic traveling over said bi-directional data bus from a plurality of output queues (OQs) to an aggregate egress queue (AEQ), wherein said input direction traffic and said output direction traffic are both comprised of a plurality of words, and wherein each of said queues has a plurality of addresses therein for storing words, said method comprising:
a) dividing a window into a data scheduling frame having a size sufficient for a number of word transactions and a pointer scheduling frame;
b) dividing said data scheduling frame into an input scheduling frame and an output scheduling frame;
c) during said input scheduling frame, writing a number of words stored in said AIQ to at least one of said IQs over said bi-directional data bus;
d) during said output scheduling frame, reading a number of words destined for said AEQ and stored in at least one of said OQs over said bi-directional data bus by, for each of said number of stored words destined for said AEQ, (1) selecting a non-empty OQ, (2) determining a value representing an occupancy for said selected OQ, (3) determining a number of output transactions for said selected OQ as a function of said determined occupancy value for said QQ, (4) if said output scheduling frame has a duration sufficient to accommodate said determined number of output transactions, reading a number of words from said selected OQ equal to said determined number of output transactions, and (5) if said output scheduling frame duration is insufficient to accommodate said determined number of output transactions, reading words from said selected IQ until said output scheduling frame terminates; and
e) during said pointer scheduling frame, updating at least one pointer for at least one of said IQs or at least one of said OQs, wherein each pointer identifies a queue address to which a next word will be written or from which a next word will be read.

56. The method of claim 55 wherein said step of determining a number of output transactions includes determining said number of output transactions as a function of a predetermined occupancy damping factor.

57. The method of claim 56 wherein said step of determining a number of output transactions further includes determining said number of output transactions as a function of a predetermined baseline number of output transactions.

58. The method of claim 55 wherein said step of determining a number of output transactions includes determining said number of output transactions as a function of a predetermined baseline number of output transactions.

59. The method of claim 55 wherein said OQ selecting step includes selecting a non-empty OQ in a round-robin fashion.

60. A method of controlling data flow on a bi-directional data bus, wherein said data flow comprises input direction traffic traveling over said bi-directional data bus from an aggregate ingress queue (AIQ) to a plurality of input queues (IQs) and output direction traffic traveling over said bi-directional data bus from a plurality of output queues (OQs) to an aggregate egress queue (AEQ), wherein said input direction traffic and said output direction traffic are both comprised of a plurality of words, and wherein each of said queues has a plurality of addresses therein for storing words and pointers, wherein each IQ has stored therein at least two copies of an input read pointer and at least two copies of an input write pointer, wherein each OQ has stored therein at least two copies of an output read pointer and at least two copies of an input read pointer, said method comprising:
a) dividing a window into a data scheduling frame having a duration sufficient for a number of word transactions and a pointer scheduling frame;
b) dividing said data scheduling frame into an input scheduling frame and an output scheduling frame;
c) during said input scheduling frame, writing a number of words stored in said AIQ to at least one of said IQs over said bi-directional data bus;
d) during said output scheduling frame, reading a number of words stored in at least one of said OQs and destined for said AEQ over said bidirectional data bus; and
e) during said pointer scheduling frame, updating said pointers for at least one of said IQs and at least one of said OQs, by (1) selecting an IQ and an OQ, (2) reading both copies of the input read pointer stored in said selected IQ, (3) reading both copies of the output write pointer stored in said selected OQ, (4) comparing both copies of said input read pointers to determine whether a match exits, (5) comparing both copies of said output write pointers to determine whether a match exists, (6) if a match exists between said input read pointer copies, updating an internal input read pointer value for said selected IQ with said read input read pointer, and (7) if a match exists between said output write pointer copies, updating an internal output write pointer value for said selected OQ with said read output write pointer.

61. The method of claim 60 wherein said pointer updating step includes:
in said selected IQ, overwriting both copies of said stored input write pointer with an internal input write pointer; and
in said selected OQ, overwriting both copies of said stored output read pointer with an internal output read pointer.

62. The method of claim 60 wherein said step of selecting an IQ and an OQ includes selecting an IQ and an OQ in a round-robin fashion.
